(19) United States
(12) Patent Application Publication
(10) Pub. No.: US 2026/0188123 A1
(43) Pub. Date: Jul. 2, 2026

(54) Contingency Planning

(71) Applicant: Joby Aero, Inc., Santa Cruz, CA (US)

(72) Inventors: Christabelle Simone Juliette Bosson, Mountain View, CA (US); Eric Richard Mueller, San Francisco, CA (US)

(21) Appl. No.: 19/202,878

(22) Filed: May 8, 2025

Related U.S. Application Data
(60) Provisional application No. 63/644,245, filed on May 8, 2024.

(51) Int. Cl. G08G 5/26; B64C 29/00; G08G 5/30; G08G 5/54

(52) U.S. Cl. CPC G08G 5/26; B64C 29/00; G08G 5/30; G08G 5/54

(57) ABSTRACT

A computer-implemented method includes accessing route data indicative of a route for a first aircraft to fly within a geographic area. The method includes accessing data indicative of a plurality of contingency landing locations within the geographic area. The method includes processing such data to compute a contingency landing plan that assigns at least one respective contingency landing location to each route segment of the first aircraft. The method includes accessing data indicative of a change in flight operations of a second aircraft that is in-flight within the geographic area and computing an updated contingency landing plan for the first aircraft based on the change in the flight operations of the second aircraft. The method includes transmitting, over a network to a computing device associated with the first aircraft, one or more signals indicative of the updated contingency landing plan.

### FIELD

The present disclosure relates generally to contingency planning for a fleet of aircraft. For example, the present disclosure utilizes real-time data to iteratively update contingency landing locations for aircraft at each point during a flight, as well as communicate the latest contingency landing location to the aircraft operator while the aircraft is in-flight.

### BACKGROUND

Aircraft contingency planning allows an aircraft to land at an alternative landing location instead of an originally planned destination. The alternative landing location can be selected by a pilot, who can then navigate the aircraft to the alternative landing location.

### SUMMARY

Aspects and advantages of implementations of the present disclosure will be set forth in part in the following description, or may be learned from the description, or may be learned through practice of the implementations.

One example aspect of the present disclosure is directed to a computer-implemented method. The method includes accessing route data indicative of a route for a first aircraft to fly within a geographic area, the route comprising a plurality of route segments. The method includes, based on the geographic area, accessing data indicative of a plurality of contingency landing locations. The method includes computing a contingency landing plan for the first aircraft based on the route data and the data indicative of the plurality of contingency landing locations, wherein the contingency landing plan assigns at least one respective contingency landing location to each route segment of the plurality of route segments. The method includes accessing data indicative of a change in flight operations of a second aircraft that is in-flight within the geographic area. The method includes computing an updated contingency landing plan for the first aircraft based on the change in the flight operations of the second aircraft, the updated contingency landing plan comprising at least one change in the contingency landing locations assigned to the first aircraft for the route. The method includes transmitting, over a network to a computing device associated with the first aircraft, one or more signals indicative of the updated contingency landing plan.

In some example implementations, the computer implemented further includes accessing contingency event data associated with a predicted landing maneuver of the first aircraft. In some example implementations, the method includes computing, based on the contingency event data, one or more recommended contingency landing locations of the plurality of contingency landing locations, wherein one or more recommended contingency landing locations are associated with a landing maneuver corresponding to the predicted landing maneuver. In some example implementations, the method includes transmitting one or more command instructions to the first aircraft to notify an aircraft operator of the one or more recommended contingency landing locations.

In some example implementations, the contingency event data is associated with a deviation from at least one route segment.

In some implementations, the landing maneuver is associated with at least one of: (i) a vertical landing or (ii) a conventional landing.

In some example implementations, the first aircraft is a vertical take-off and landing (VTOL) aircraft.

In some example implementations, the computer-implemented method further includes accessing aircraft data indicative of one or more capabilities of the first aircraft. In some example implementations, the method includes computing, based on the one or more capabilities of the first aircraft, the one or more recommended contingency landing locations.

In some example implementations, the capabilities of the first aircraft are associated with a flight range of the first aircraft in response to a contingency event.

In some example implementations, the change in flight operations includes at least one of: (i) a flight delay, (ii) data change in a route of the second aircraft, or (iii) a change in a capacity of at least one respective contingency landing location indicated in the contingency landing plan of the first aircraft.

In some example implementations, the plurality of contingency landing locations accommodate at least one of: (i) a vertical landing or (ii) a conventional landing.

In some example implementations, the data indicative of the plurality of contingency landing locations comprises capacity data indicative of a respective capacity of each of the plurality of contingency landing locations.

In some example implementations, accessing data indicative of the change in flight operations of the second aircraft includes accessing location data indicative of a position of the second aircraft within the geographic area.

In some example implementations, the computer-implemented method further includes accessing data indicative of a change in flight operations of a third aircraft that is in-flight within the geographic area.

In some example implementations, the landing maneuver is associated with at least one of: (i) a vertical landing or (ii) a conventional landing.

In some example implementations, computing the updated contingency landing plan for the first aircraft includes accessing fleet route data indicative of one or more routes for respective aircraft within a fleet of aircraft. In some example implementations, computing the updated contingency landing plan for the first aircraft includes computing an impact of the updated contingency landing plan for the first aircraft, wherein the impact is indicative of one or more deviations of the one or more routes for the respective aircraft within the fleet of aircraft.

In some example implementations, the route for the first aircraft is a transportation route to transport one or more passengers in response to a transportation request.

In some example implementations, the plurality of route segments is associated with a path of travel from a first vertiport to a second vertiport.

In some example implementations, the at least one change in the contingency landing locations is associated with one or more contingency landing locations within a threshold distance from the first aircraft.

In some example implementations, the at least one respective contingency landing location to each route segment is a nearest contingency landing location of the plurality of contingency landing locations.

In some example implementations, data indicative of a change in flight operations is accessed from a storage system associated with transportation service.

Another example aspect of the present disclosure is directed to a computing system. The computing system includes one or more processor and one or more non-transitory computer-readable media storing instructions executable by the one or more processors to perform operations. The operations include accessing route data indicative of a route for a first aircraft to fly within a geographic area, the route comprising a plurality of route segments. The operations include, based on the geographic area, accessing data indicative of a plurality of contingency landing locations. The operations include computing a contingency landing plan for the first aircraft based on the route data and the data indicative of the plurality of contingency landing locations, wherein the contingency landing plan assigns at least one respective contingency landing location to each route segment of the plurality of route segments. The operations include accessing data indicative of a change in flight operations of a second aircraft that is in-flight within the geographic area. The operations include computing an updated contingency landing plan for the first aircraft based on the change in the flight operations of the second aircraft, the updated contingency landing plan comprising at least one change in the contingency landing locations assigned to the first aircraft for the route. The operations include transmitting, over a network to a computing device associated with the first aircraft, one or more signals indicative of the updated contingency landing plan.

In some example implementations, the operations include any of the example method(s).

Yet another example aspect of the present disclosure is directed to one or more non-transitory, computer-readable media storing instructions that are executable by one or more processors to cause the one or more processors to perform operations. The operations include accessing route data indicative of a route for a first aircraft to fly within a geographic area, the route comprising a plurality of route segments. The operations include, based on the geographic area, accessing data indicative of a plurality of contingency landing locations. The operations include computing a contingency landing plan for the first aircraft based on the route data and the data indicative of the plurality of contingency landing locations, wherein the contingency landing plan assigns at least one respective contingency landing location to each route segment of the plurality of route segments. The operations include accessing data indicative of a change in flight operations of a second aircraft that is in-flight within the geographic area. The operations include computing an updated contingency landing plan for the first aircraft based on the change in the flight operations of the second aircraft, the updated contingency landing plan comprising at least one change in the contingency landing locations assigned to the first aircraft for the route. The operations include transmitting, over a network to a computing device associated with the first aircraft, one or more signals indicative of the updated contingency landing plan.

In some example implementations, the operations include any of the example method(s).

Other example aspects of the present disclosure are directed to other systems, methods, vehicles, apparatuses, tangible non-transitory computer-readable media, and devices for using battery modelling technology to generate and adjust aircraft itineraries and operations, as well as controlling aircraft and other vehicles associated therewith.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example multi-modal transportation service according to example implementations of the present disclosure;

FIG. 2A depicts an example computing ecosystem according to example implementations of the present disclosure;

FIGS. 2B-C depict example computing device registers according to example implementations of the present disclosure;

FIG. 3 depicts an example dataflow pipeline according to example implementations of the present disclosure;

FIG. 4 depicts an aerial view of example aerial route segments according to example implementations of the present disclosure;

FIGS. 5A-B depict example data structures according to example implementations of the present disclosure;

FIG. 6 depicts an aerial view of example contingency landing locations in a geographic region according to example implementations of the present disclosure;

FIG. 7 depicts an example data structure of filtered contingency landing locations according to example embodiments of the present disclosure;

FIG. 8 depicts an example aerial view of contingency landing locations assigned to route segments along a route according to example implementations of the present disclosure

FIG. 9 depicts an example aerial view of an example aircraft causing a change to a contingency landing location according to example implementations of the present disclosure;

FIG. 10 depicts an example data structure of an updated contingency landing location according to example implementations of the present disclosure;

FIG. 11 depicts an example data structure of filtered contingency landing locations according to example embodiments of the present disclosure;

FIG. 12 depicts an example computing ecosystem according to example implementations of the present disclosure;

FIG. 13 depicts an example user interface according to example embodiments of the present disclosure;

FIGS. 14A-E depict flowchart diagrams of example computer-implemented methods according to example embodiments of the present disclosure; and

FIG. 15 depicts a block diagram of an example computing system according to example embodiments of the present disclosure.

### DETAILED DESCRIPTION

Generally, the present disclosure is directed to techniques for real-time assignment and automated adjustment of contingency landing locations for a fleet of aircraft within a dense operating environment. For example, a fleet of vertical takeoff and landing (VTOL) aircraft can be used to transport riders within busy metropolitan areas. In such an environment, aircraft operate in tighter airspace, and landing locations (e.g., rooftop vertiports) are more limited in space than traditional commercial airports and landing strips. As such, the technology of the present disclosure may take into account how dynamic, real-time changes to the operations of one aircraft may impact another as opposed to more traditional techniques. A contingency planning system can use the real-time data to iteratively update recommended contingency landing locations for an aircraft at each point during a route.

Prior to take-off, a computing system can access aircraft route data to compute initial contingency landing plans for aircraft. The contingency landing plans can include a contingency landing location for each segment along the aircrafts' planned route. As the aircraft fly along their route segments, the computing system can iteratively update a datastore to indicate which aircraft are currently assigned to each contingency landing location. In an embodiment, the computing system may be a centralized or de-centralized system which can be used to manage the datastore across multiple VTOL operators that may independently operate aircraft within the same geographic region or airspace.

The computing system can track aircraft operations and update contingency plans in real-time to proportionately assign the contingency landing locations. For example, while the aircraft are in-flight, the computing system can access data indicating a change in flight operations of the aircraft (e.g., delayed flight, re-rerouting, etc.). The computing system can also detect any updated circumstances, such as weather, that may restrict the aircraft to a conventional landing only, vertical landing only, etc.

Using this information, for an individual aircraft, the computing system can generate an updated contingency landing plan that takes into account the real-time operations of other aircrafts that are operating nearby as well as any constraints on the particular aircraft. The updated contingency landing plan can indicate any newly assigned contingency locations and their associated route segment. This can be done in a manner to proportionately assign each contingency landing location to ensure that the aircraft in the fleet and other aircraft operating in the same geographic region can perform a contingency landing along any route segment, if needed.

The computing system can update the datastore to reflect the updated contingency assignments and monitor the capacity for each landing location. Additionally, the updated contingency landing plans can be communicated to the VTOL operators to provide a more immediate contingency options in real-time. In this way, the contingency landing locations within a dense urban environment can be intelligently assigned to allow aircraft to perform a contingency landing at any point along a flight. Moreover, conflicts in contingency landing location assignments with other VTOL operators may be resolved in real-time.

The technology of the present disclosure can provide a number of technical effects and improvements to computing and aircraft technology. For instance, the technology of the present disclosure can compute an expected impact to contingency landing locations across a fleet of aircraft and fleets of other VTOL operators given a certain flight plans and changes to flight operations. A contingency planning system can ingest this information along with aircraft data associated with a specific aircraft to determine the range/available time of flight of an aircraft at various times along a flight. In this way, the technology of the present disclosure provides an improved approach for automatically determining contingency landing locations in a manner that is specifically tailored to a particular flight plan as well as the specifications of an aircraft and its energy storage system (e.g., vehicle/battery specifications and capabilities, charge, capacity, type, age, wear, tendencies, etc.). This also allows the contingency planning system to predict the future operating state of a transportation service more accurately. As a result, a contingency planning system can utilize the contingency planning system to implement a customized solution for automatically generating updated contingency landing plans that are specifically tailored for the aircraft based on its onboard capabilities.

Moreover, the technology of the present disclosure can allow aircraft operators to focus on more discrete tasks while operating the aircraft, help improve real-time control decisions, while minimizing the effects of changes in flight operations of the overall transportation operations. Ultimately, the automation provided by the present disclosure can increase computational efficiencies for both a network system and onboard the aircraft, while also increasing coordination among one or more VTOL operator fleets and reducing pilot burden when performing a transportation service.

### Example Transportation Service

A fleet of aircraft can perform a transportation service to transport riders to requested destinations. This can include an on-demand transportation service that is provided within a dense urban environment, with shorter flights, and at lower altitudes than those typically provided by commercial airlines. One example on-demand transportation service can include a multi-model transportation service.

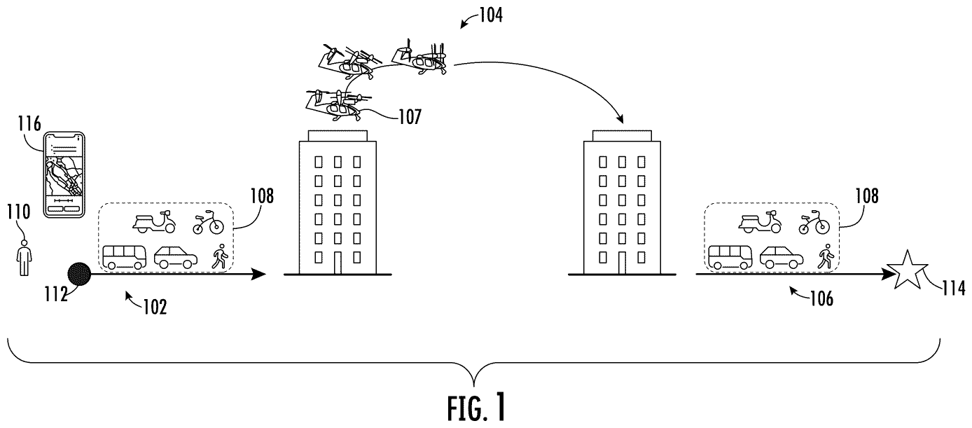

FIG. 1 depicts an example process flow of a multi-modal transportation service according to example implementations of the present disclosure. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The aerial transport can include one or more different aircraft such as airplanes, vertical take-off and landing vehicles (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 1, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically (e.g., in a hover mode) and a second rotor position that allows the aircraft to travel forward using a thrust force (e.g., in a cruise mode). This can allow the aircraft to take-off and land vertically or perform a conventional take-off and landing.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multi-modal transportation service. Responsive to selection of the multi-modal transportation service option by the user 110, the service can be initiated for transportation for user 110.

To track and coordinate the multi-modal transportation service, a user itinerary can be computed for the user 110. A user itinerary (also referred to as a “multi-modal itinerary”) can be defined by a data structure that includes various information associated with a user's trip from an origin location to a destination location. As used herein, user itinerary may refer to the user itinerary or the underlying data structure depending on the context. The user's itinerary may include: identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

The itinerary of the user 110 can be based on the user's origin location, destination location, available intermediate locations for transitioning between transportation modalities, vehicle routes, and/or other information.

### Example Computing Ecosystem for Coordinating Transportation Services

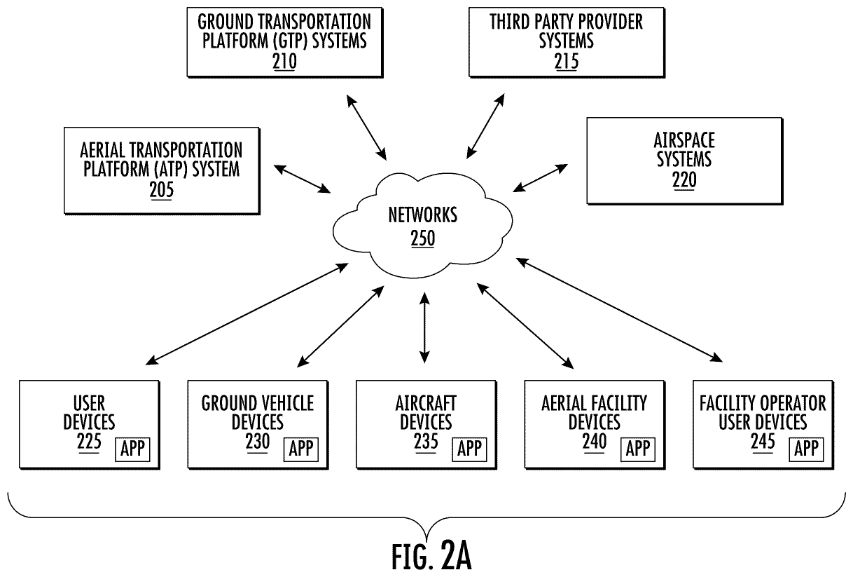

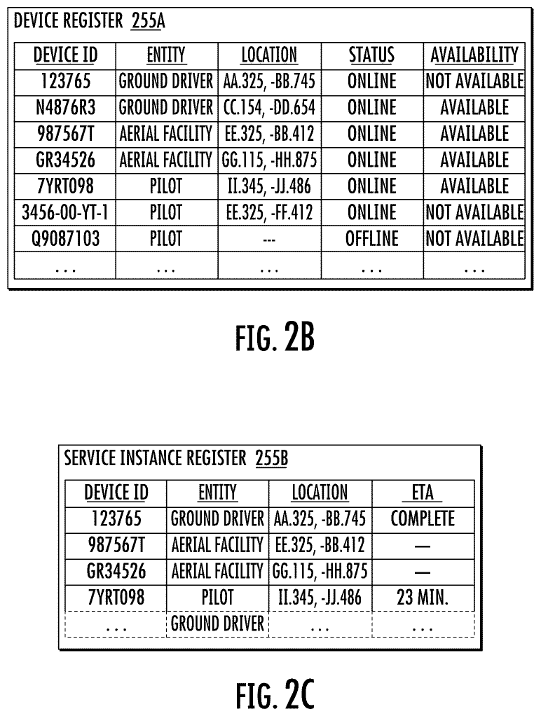

Coordinating aircraft to provide transportation services can include a distributed computing network. FIG. 2A depicts a block diagram illustrating an example networked ecosystem 200 for cross-platform coordination for transportation services. Multiple network-connected systems can cooperatively interact within ecosystem 200 to provide transportation services. As shown, ecosystem 200 may include a distributed computing system with a plurality of different participating systems/devices communicatively connected over one or more networks 250.

The ecosystem 200 can include one or more transportation platform systems such as, for example, an aerial transportation platform (ATP) system 205 and one or more ground transportation platform (GTP) systems 210. The ecosystem 200 can include third-party provider systems 215, airspace systems 220, user devices 225, ground vehicle devices 230, aircraft devices 235, aerial facility devices 240, or facility operator user devices 245.

Each of the systems or devices can communicate over one or more wireless or wired networks 250. Networks 250 can include one or more types of networks including telecommunications networks, internet, private networks, or other networks, as further described herein.

The systems and devices of ecosystem 200 can include a plurality of software applications operating on the respective systems and devices. This can create an ecosystem of applications for providing and coordinating a multi-modal transportation services, as further described herein.

User devices 225 can include computing devices owned or otherwise accessible to a user of a transportation service. For example, a user device 225 can include a hand-held computing device (e.g., a phone, a tablet, etc.), a wearable computing device (e.g., smart watch, smart glasses, etc.), personal desktop devices, or other devices. User devices 225 can execute one or more instructions to run an instance of a software application for a respective transportation platform and present user interfaces associated therewith. User devices 225 can include personal devices (e.g., a mobile device) or shared devices on which a user has initiated a personal session (e.g., by logging into a public kiosk or display device in a vehicle, etc.).

A GTP system 210 can be associated with a service entity that provides a ground transportation service. GTP systems 210 can include a computing platform (e.g., a cloud services platform, server system, etc.) communicatively connected over networks 250 to one or more of the systems or devices of networked ecosystem 200.

GTP systems 210 can include or implement one or more client-facing software applications accessible to the devices of ecosystem 200. Users can interact with the GTP systems 210 (e.g., using user devices 225, ground vehicle devices 230, aircraft devices 235) to receive various types of transportation services (e.g., delivery, ridesharing, or ride-hailing, etc.) including multi-modal transportation services. For example, a GTP system 210 can match one of its associated ground vehicles or operators with users for a ground transportation service.

GTP systems 210 can be associated with ground infrastructure for facilitating the performance of a ground transportation service. The ground infrastructure can include one or more parking areas, vehicle transfer hubs, charging/fueling locations, storage facilities, etc.

GTP systems 210 can be associated with a fleet of ground vehicles and the vehicle operators can include a network of ground vehicle operators. As described herein, ground vehicles can include automobiles, bikes, scooters, autonomous vehicles, etc. The network of ground vehicle operators can include drivers or remote operators that facilitate, oversee, or control the movement of ground vehicles available to perform ground transportation services.

Ground vehicle devices 230 can include computing devices or systems associated with a ground vehicle or operator. For example, ground vehicle devices 230 can include one or more vehicle computing systems such as, for example, an onboard computer for operating the vehicle, an autonomy system, an infotainment system, etc. Additionally, or alternatively, ground vehicle devices 230 can include an operator's user device. For example, a ground vehicle device can be a driver's mobile phone. In some implementations, ground vehicle devices 230 can include a user device that remains onboard a ground vehicle such as, for example, a tablet that is available to an operator or passenger.

An ATP system 205 can be associated with one or more service entities that provide at least an aerial transportation service to users. ATP system 205 can include a computing platform (e.g., a cloud services platform, server system, etc.) communicatively connected over networks 250 to one or more of the systems or devices of networked ecosystem 200.

ATP systems 205 can include or implement one or more client-facing software applications accessible to the devices of ecosystem 200. Users can interact with ATP system 205 (e.g., using user devices 225, ground vehicle devices 230, aircraft devices 235) to receive various types of information related to a transportation service. For example, a user (e.g., a rider) can interact with ATP system 205 via an instance of a software application (e.g., a rider app) running on user device 225 to request and book a transportation service. A facility operator can interact with ATP system 205 via an instance of a software application (e.g., an operations app) running on an aerial facility device 240 or a facility operator user device 245 to view/adjust flight information, seat assignments, etc.

In some implementations, the software application of one system can be run within or accessed by the software application of another system. For example, a user interface of a software application associated with an ATP system 205 can be embedded within and displayed with the user interface of the software application associated with the GTP system 210, or vice versa. This can allow a user to utilize one application, while accessing another for a particular transportation leg (e.g., aerial transport).

ATP systems 205 can be associated with one or more aircraft, aircraft operators, aerial facilities (or portions thereof), facility operators, etc. for facilitating the performance of at least an aerial transportation service. For example, the aircraft can include a fleet of aircraft and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 240. Aerial facility devices 240 can be positioned at various locations within or around the aerial facility to collect and receive information associated with an aerial transportation service. Aerial facility devices 240 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc.

Aerial facility devices 240 can include a computing system associated with a particular aerial facility. The computing system can maintain a data structure that is indicative of the total capacity of the aerial facility (e.g., how many aircraft can possibility be located at, stored, etc.) and the current capacity (e.g., which/how many aircraft are currently located, stored, etc. at the facility). The computing system can maintain a data structure that indicates the number of and the identity of the aircraft that are assigned to the aerial facility for a contingency landing. Such information can be provided to the aerial facility devices 240 by an ATP system 205. This can allow the aerial facility to maintain an understanding of its real-time capacity via a local computing system.

Facility operators can be associated with an aerial facility to assist users with security checks, check-ins, boarding/de-boarding, performing aircraft checks, etc. The facility operator user devices 245 can include user devices utilized by the facility operators. Facility operator user devices 245 can be used to communicate with a transportation platform or perform various functions at an aerial facility. For example, facility operator user devices 245 can run one or more software applications to complete security checks, check in/out luggage, coordinate re-charging/re-fueling, present safety briefings, or the like.

Aircraft devices 235 can include one or more aircraft computing systems or aircraft operator user devices. For instance, aircraft devices 235 can include a computing system onboard an aircraft such as a pilot interface, an avionics system, an infotainment system, a navigation system, an autonomy system, or any other sensors or devices located on an aircraft and capable of sending or receiving information. Aircraft devices 235 can include an aircraft operator's user device (e.g., a pilot's mobile phone). Aircraft devices 235 can include a user device that remains onboard the aircraft such as, for example, a tablet or display that is available to a passenger or operator.

The ecosystem 200 can include one or more airspace systems 220. Airspace systems 220 can include one or more airspace data exchanges or otherwise be associated with regulatory bodies configured to collect real-time, historical, or regulatory airspace data. The airspace systems 220 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.). In some implementations, the airspace system 220 can be associated with a weather service that provides weather data associated with an airspace in which the aircraft are, or will be, operating.

The ecosystem 200 can include one or more third-party provider systems 215. Third-party provider systems 215 can be associated with one or more third parties that provide resources to ATP systems 205 or GTP systems 210. For example, third-party provider systems 215 can be associated with a third-party aircraft provider, including one or more “third-party” aircraft. Third party aircraft can include aircraft provided, leased, loaned, or otherwise made available by an entity for use by ATP systems 205 for transportation services, as further described herein.

Additionally, or alternatively, third-party provider systems 215 can be associated with a provider of one or more third-party aircraft operators. Third-party aircraft operators can include, for example, a plurality of aircraft pilots that may be available to ATP systems 205 for operation of an aircraft for the transportation services.

In some implementations, third-party provider systems 215 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP systems 205 or GTP systems 210 can communicate directly or indirectly (e.g., through third-party provider systems 215) with the third-party aircraft, operators, or infrastructure.

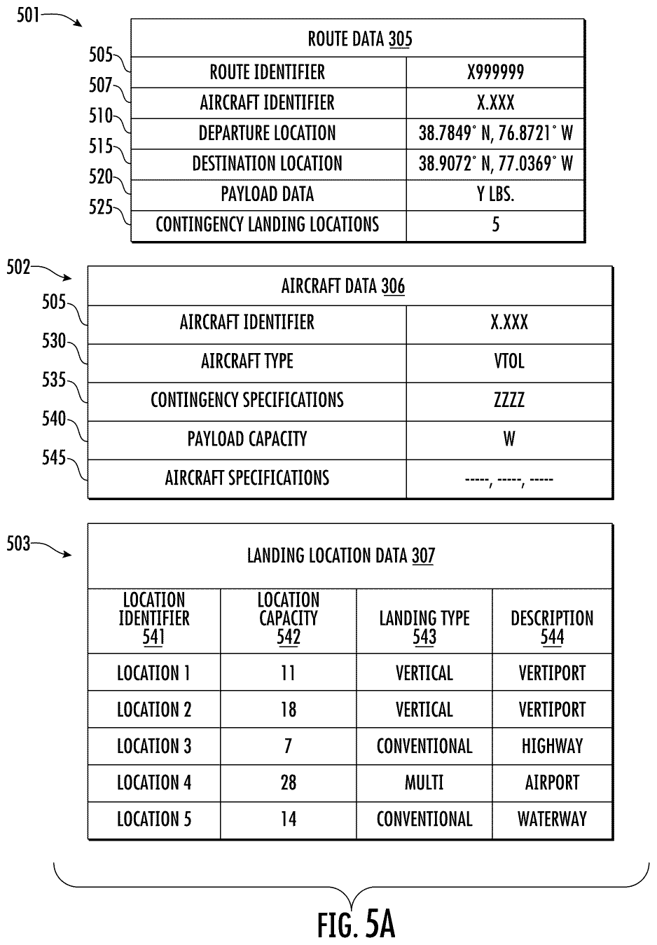

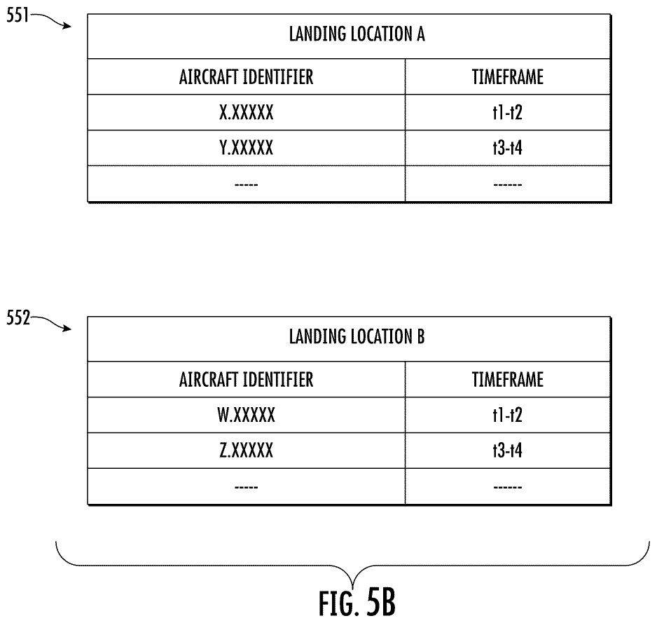

The systems and devices of ecosystem 200 may be registered for potential use when providing and coordinating a transportation services. FIG. 5A illustrates an example device register 255A. Device register 255A can include a table or other data structure indicating devices/systems participating in the on-demand transportation platform ecosystem, such as ecosystem 200. Device register 255A can include fields such as Device ID, Entity, Location, Status, Availability, etc.

The device register 255A can be maintained in a local or remote database. Systems and devices can register for participation in ecosystem 200 by providing information to a registration service. Such information can include system/device identifiers, associated entities, IP addresses, downloading an application, signing-up or creating an account, or other information for identifying and communicating with the system/device. The device register 255A can be updated to provide a real-time reference for the characteristics and status of participating systems/devices. This can include, for example, determining whether a device is online or offline (e.g., powered on and connected, or not) or whether the device is available (e.g., not currently being utilized for another task) or unavailable (e.g., being utilized for another task).

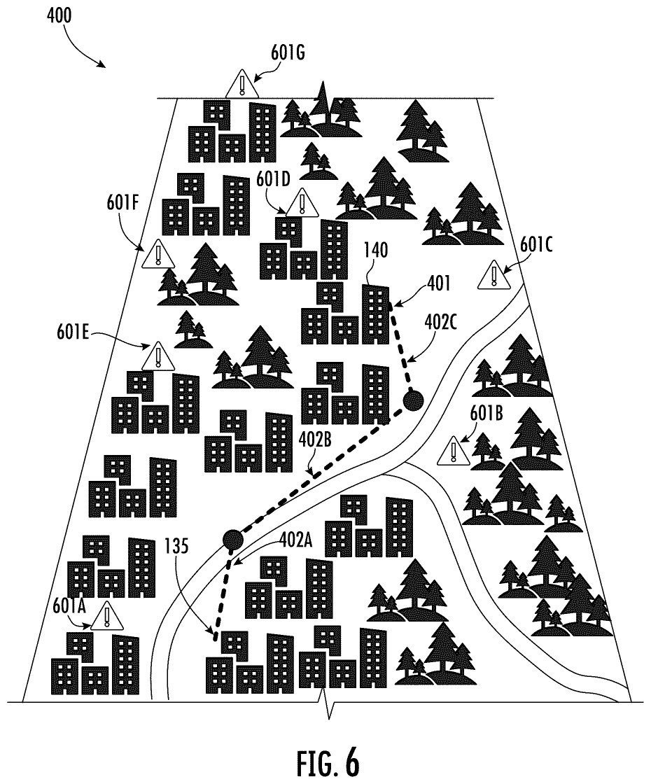

A service instance register can be created, such as an example service instance register 255B shown in FIG. 6. A service instance register 255B can include a data structure with one or more data objects that indicate the devices to be utilized for facilitating and progressing a user along their journey.

An ATP system 205 (or another system) can build a service instance register 255B for servicing a particular service request. Service instance register 255B can be associated with a unique or distinct service instance identifier for a particular user itinerary for providing at least one leg of a transportation service. Service instance register 255B can assemble a selection of participating devices from device register 255A. Service instance register 255B can include a minimum set of participating devices to complete at least a leg of a journey. Service instance register 255B may include all participating devices to complete the entire leg of a journey. This can include, for example, the aerial facility devices 240 for any origin and destination aerial facilities, as well as any contingency locations.

The ATP system 205 (or another system) can update and reconfigure service instance register 255B as needed to accommodate for scheduling changes, delays, device substitution, etc. or as the journey/itinerary progresses for a particular user. For example, as the user progresses along a second leg of a particular journey, the ATP system 205 may identify a contingency location for a particular route segment (as further described herein), and update the service register 255B to include the aerial facility devices 240 associated with the contingency location. The aerial facility devices 240 can be updated as the user progresses and the contingency location changes as the route segment changes. In this manner, service instance registers 255B can accurately reflect, in real-time, the systems/devices of the ecosystem 200 that are associated with each particular service instance for the users of the transportation service.

### Example Computing System for Contingency Planning

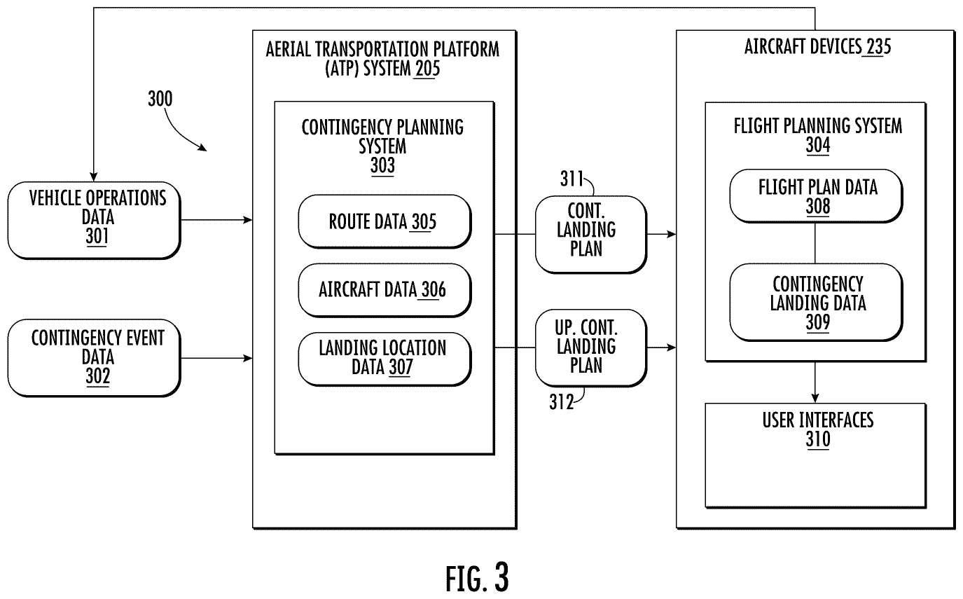

The ATP system 205 can manage and maintain contingency landing locations for aircraft assigned to perform a transportation service. For example, FIG. 3 depicts an example dataflow pipeline 300 for managing and maintaining contingency landing locations for aircraft according to example implementations of the present disclosure.

The example dataflow pipeline 300 is described with an example implementation in which data is consumed by the contingency planning system 303 running one or more servers of the ATP system 205 to compute, and update, contingency landing plans for aircraft. For instance, the contingency planning system 303 can ingest route data 305, aircraft data 306, and landing location data 307 to compute a contingency landing plan 311. The contingency landing plan 311 can be provided to the aircraft devices 235 of an aircraft.

A flight planning system 304 of the aircraft can utilize flight plan data 308 to help a pilot (or an autonomy system) navigate the aircraft along a route. The flight planning system 304 can utilize the contingency landing plan 311 to generate contingency landing data 309, which can be rendered via one or more user interfaces 310 to indicate contingency landing locations along the route. The contingency planning system 303 can continue to ingest vehicle operations data 301 from the fleet of aircraft and generate an updated contingency flight plan 312, as needed. If a contingency event occurs, the aircraft can be navigated to a contingency landing location. Additionally, or alternatively, the contingency planning system 303 can ingest contingency event data 302 to further update the contingency plans, if needed.

The following will now describe the components of the example data pipeline 300 in greater detail.

The contingency planning system 303 can include software running on one or more servers within the ATP system 205. The contingency planning system 303 can be a sub-system of the ATP system 205 and utilize shared computing resources. While examples herein describe the contingency planning system 303 as a sub-system of the ATP system 205, the contingency planning system 303 can be a standalone system (e.g., within the computing ecosystem 200) or implemented within another system.

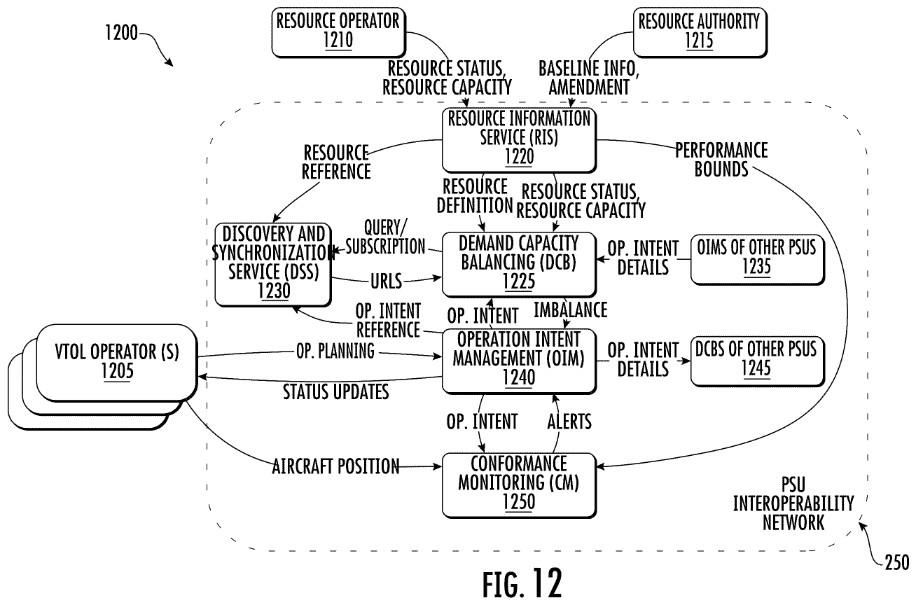

For example, the contingency planning system 303 may be implemented as a centralized or decentralized system accessible to multiple VTOL operators. In this manner, the contingency planning system 303 may compute, and update, contingency landing plans for aircraft across multiple fleets of aircraft operating within the same geographic region. An example of a contingency planning system 303 accessible to multiple VTOL operators is further described with reference to FIG. 12.

The contingency planning system 303 can be programmed to manage and maintain contingency landing locations for aircraft. Contingency landing locations can include aerial facilities, aerial infrastructure, or any suitable location where aircraft may land. In an urban environment, this may include vertiports, building rooftops, open ground-level areas, private airports, etc. Contingency landing locations provide alternative landing accommodations to aircraft in the event that the aircraft is unable to reach a predetermined destination.

The contingency planning system 303 can proportionately assign contingency landing locations for each aircraft prior to take-off and in-flight such that each aircraft, across a fleet of aircraft, maintains an assigned contingency landing location available at each point during a flight. As further described herein, this can include computing an initial contingency landing plan 311 prior to take-off and an updated contingency flight plan 312, while the aircraft is in-flight.

The contingency planning system 303 can access various types of data to help perform its functions. Accessing data can include performing look-up functions, API calls, queries, pulls, pushes, etc.

The contingency planning system 303 can access route data 305. Route data 305 can be stored in a simple or complex data structure within the contingency planning system 303 or another system. This can include storing the aircraft data 306 in a simple array and/or linked list.

Route data 305 can include concatenated information associated with routes assigned to aircraft to facilitate a transportation service in a geographic area. A route can include a path for the aircraft from an origin to a destination. A route can be divided into a plurality of route segments. A route segment can include a portion of a route that is less than the entire route. For example, a 10 mile route may be broken into five route segments, each approximately 2 miles. A route (and its route segments) may include a series of waypoints for an aircraft to follow. The route data 305 can indicate a route and can include information associating a particular aircraft or plurality of aircraft with a route and its route segments.

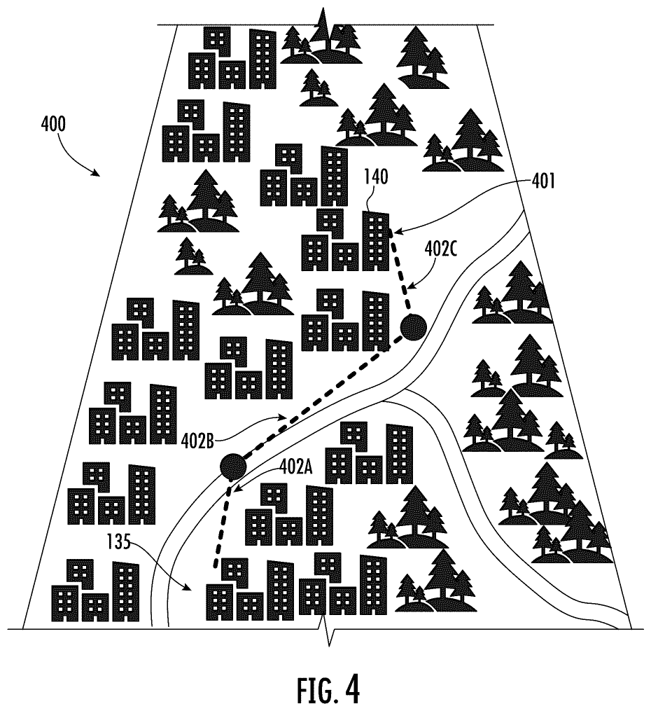

FIG. 4 depicts a geographical area 400 with a route 401 of an aircraft according to example implementations of the present disclosure. The geographic region 400 can be, for example, an urban environment. While examples herein describe the geographic region 400 as being an urban environment, the geographic region 400 may include larger regions such as areas that cross county, state, or province boundaries or smaller regions such as a collections of blocks or streets within a metropolitan area.

The geographic area 400 can include a network of locations that can be used for transitioning a user from one transportation modality to another. For instance, the geographic area 400 can include a plurality of aerial facilities 135, 140. The aerial facilities 135, 140 (e.g., vertiports) can be placed at various locations within the geographic area 400.

The plurality of aerial facilities 135, 140 can be connected by a one or more routes that can be utilized by an aircraft to transport users, cargo, etc. between locations. For example, the route 401 can be utilized by an aircraft to transport riders from a first aerial facility 135 to a second aerial facility 140.

The route 401 can include a plurality of route segments 402A-C. In some implementations, the route segments 402A-C can be designed with respect to airspace constraints (e.g., noise constraints, air traffic constraints, etc.). In some implementations, demand modeling can be performed to select high value infrastructure locations for placing the plurality of aerial facilities 135, 140 throughout the geographic area 400 and generating a route 401 and route segments 402A-C between the aerial facilities 135, 140, without interfering with the airspace constraints. This network of aerial facilities 135, 140 and route segments 402A-C can be utilized to create flight plans for aircraft used within a transportation service to indicate how and where a particular aircraft 150 may travel through an operational time period.

The route data 305 may include various types of information. FIG. 5A shows an example data structure 501 that includes route data 305. Data structure 501 can include a database table storing route data 305 for a geographic region. While examples herein illustrate the data structure 501 as database tables, the present disclosure is not limited to such embodiment. The data structure 501 can be any simple or complex data structure capable of organizing and concatenating data from multiple data sources.

Route data 305 can include information associated with routes assigned to a fleet of aircraft operating in a transportation service. For instance, route data 305 can include route identifier data 505 to identify particular routes assigned to an aircraft. The route identifier data 505 can include one or alphanumerical characters which identify a particular route.

Route data 305 can include or be associated with an aircraft identifier 507 that indicates the aircraft assigned to the associated route. For example, the aircraft data 306 can be concatenated with route identifier data 505 to generate the association. aircraft identifier data 306 can include one or more alphanumerical characters which identify a particular aircraft in a fleet of aircraft. Once a route (e.g., route identifier 505) has been assigned to an aircraft, aircraft identifier data 306 can be concatenated with the route identifier data 505 along with route details.

The route data 305 can include certain flight itinerary information. For example, the route data 305 can include the departure location 510 and destination location 515 of the aircraft assigned to the route. This information can be expressed as coordinates, addresses, place names, etc. In some examples, the departure location 510 and destination location 515 can be intermediate locations within a multi-modal transportation service. The route data 305 can indicate departure times, arrival times, estimate times and durations for traveling along a particular route segment, etc. Such information can be reflective of a schedule associated with an expected departure time and arrival time of the aircraft.

The route data 305 can include the locations of waypoints of the route. The waypoints can be expressed, for example, in latitudinal and longitudinal coordinates. The route data 305 can indicate the number of route segments and the location of those route segments and/or the waypoints associated therewith.

The route data 305 can include payload data 520 indicative of a payload assigned to travel on the aircraft. The payload data 520 can indicate a total weight of a payload, a number of passengers, a number of items, a type of cargo, etc.

The route data 305 can include contingency landing locations 525 indicative of the contingency landing plan 311 or the updated contingency landing plan 312. For instance, the contingency landing locations 252 may indicate a number of initial contingency landing locations for a particular route. As vehicle operations data 301 and/or contingency event data 302 are received by the contingency planning system 303, the contingency landing locations 525 may be updated to reflect an updated number of contingency landing locations as indicated by the updated contingency landing plan 312.

While the example route data 305 depicts routing information for a single aircraft in a fleet of aircraft, a plurality of aircraft (e.g., aircraft identifier data 306) can also be concatenated with a single route identifier 505. For instance, a route can include a plurality of intermediate stops between an origin location and a destination location. As such, a plurality of aircraft can be used to transport passengers and/or cargo from the origin location to the destination location. For example, passengers and/or cargo can change aircraft at an intermediate location such as a vertiport prior to arrival at a destination location.

Returning to FIG. 3, the contingency planning system 303 can store or otherwise access aircraft data 306 indicating information specific to a particular aircraft. The aircraft data 306 can be stored within a data structure of the contingency planning system 303 or accessed from another system (e.g., aircraft device 235, etc.).

FIG. 5A shows an example data structure 502 that includes aircraft data 306. While FIG. 5A shows data structure 502 as a database table storing aircraft data 306 other types of data structures can be used. The aircraft data 306 can include the aircraft identifier 505 associated with a particular aircraft. The aircraft data 306 can indicate an aircraft type 530 (e.g., VTOL, helicopter, CTOL, etc.). The aircraft data 306 can indicate aircraft specifications 545 for an aircraft such as the aircraft's configuration, battery type and configuration, maximum altitude, flight range, performable landing maneuvers, etc.

The aircraft data 306 can indicate one or more capabilities of an aircraft. This can include, for example, contingency specifications 535 of the aircraft. The contingency specifications 535 can indicate the capabilities of an aircraft under certain contingencies. For example, the contingency specifications 535 can indicate a flight range of an aircraft in response to a contingency event (e.g., sudden severe weather event). In some implementation, the contingency specifications 535 can be based on certain standards such as ETOPS, etc. The aircraft data 306 can be updated in real-time to indicate the current capabilities of the aircraft, including while the aircraft is in-flight.

In some implementations, the aircraft data 306 can include other information. For example, the aircraft data 306 can indicate one or more operators or providers of the aircraft. Additionally, or alternatively, the aircraft data 306 can indicate the location of the aircraft. This can include, for example, a location at which the aircraft is stored or where the aircraft is located prior to its first flight.

Once, the ATP system 205 determines an aircraft can perform the transportation service (e.g., based on the aircraft characteristics associated with the aircraft), route data 305 can be updated to indicate that an aircraft has been assigned to the route to transport passengers, cargo, etc., from the departure location 510 to the destination location 515. The route data 305 can be updated to include the aircraft identifier 507 for the assigned aircraft and/or the aircraft data 306 can be updated to the route identifier 505 for the assigned route. For example, the contingency planning system 303 can concatenate the route data 305 and aircraft data 306 into a data structure such that the aircraft data 306 supplements the route data 305 with additional information of the specific aircraft or plurality of aircraft assigned to a route, or vice versa.

Returning to FIG. 3, to help generate a contingency landing plan 311 for an aircraft flying along a route, the contingency planning system 303 can access landing location data 307. The landing location data 305 can indicate one or more landing locations within a geographic area. As described herein, these landing locations can include aerial facilities (e.g., vertiports) or other areas such as a building rooftop that are suitable for landing a VTOL aircraft.

Landing location data 307 can be determined based on a survey of a geographic area to identify positions within the geographic area that can accommodate the landing of an aircraft. Landing location data 307 can be stored in a data structure and can include an index to facilitate faster searching and retrieval of contingency landing locations. For example, positions within the geographic region determined to be suitable for accommodating the landing of an aircraft can be indexed and stored in a look-up table based on the type of locations (e.g., aerial infrastructure, public property, third party infrastructure, etc.), type of landing supported (e.g., vertical, conventional, etc.), available charging, available cooling infrastructure, or any other metadata associated with the landing location.

FIG. 5A shows an example data structure 503 that includes landing location data 307. The landing location data 307 can include location identifier data 541 for each of the landing locations. The location identifier data 541 can identify a particular landing location among a plurality of landing locations in a geographic region.

The location identifier data 541 can be concatenated with characteristics of the particular landing location. For example, the location capacity 542 can be concatenated with the location identifier 541 and depict the number of aircraft which can occupy the landing location concurrently. In some examples, the location capacity 542 can include a capacity percentage or fraction to indicate the number available landing accommodations at the particular landing location. For instance, the location capacity 542 can show a “0” or “null” value to reflect that there are no available landing accommodations. The location capacity 542 can be updated in real-time based on signals from aerial facility devices 240 associated with the landing locations, signals from an aircraft, or as landing locations are assigned to aircraft (e.g., as origins/destinations for transportation services, as contingency landing locations).

In some examples, the location capacity 542 can indicate a number of available landing locations at the particular landing location based on contingency landing assignments for other aircraft during a period of time. For example, “location 1” may include a maximum of 15 landing accommodations. However, based on 4 aircraft being assigned “location 1” as a contingency landing location for concurrent or sequential routes during a period of time, the location capacity 542 for “location 1” may reflect only 11 available landing accommodations. As each of the 4 aircraft fly along their respective routes and the contingency landing assignment for “location 1” expires or terminates (e.g., aircrafts traverse beyond location 1), the location capacity 542 may be updated to reflect a current capacity of “location 1”.

Landing type data 543 can also be concatenated with the location identifier 541 to indicate the type of landing maneuvers that can be accommodated by each of the landing locations. Landing type data 543 can indicate that a landing location can accommodate only vertical landings, only conventional landings, or both. In some examples, the landing type data 543 can be updated to reflect the type of landing maneuver than can be accommodated by a landing location of the available landing accommodations. For instance, location 4 can accommodate both vertical and conventional landings as indicated by the “multi” landing type 543 designation. The landing type data 543 can be updated to reflect “conventional” or “vertical” in the event that the runway or landing pads are occupied.

The landing location data 307 can categorize the landing locations. For instance, the location identifier 541 can be concatenated with description data 544 indicating the category of contingency location. Categories can include, but are not limited to vertiports (e.g., aerial facilities), highways, waterways, open land (e.g., fields, parks, etc.), airports, or any other categorical subsets of landing options for an aircraft. The description data 544 can be used to quickly filter landing location options within a geographic region and can also be surfaced for an aircraft operator to indicate a recommended landing location.

The example data structure 503 depicts certain data types for example purposes only and is not limited to such an embodiment. The example data structures can include other data. This can include, for instance, data indicative of the infrastructure (e.g., charging, cooling) associated with a particular landing location, planned service occupancy, noise constraints, or any other considerations for aircraft operating in a particular geographic area. These additional example data types can be concatenated and utilized by the contingency planning system 303 as input for selecting landing locations for a particular route.

FIG. 6 depicts example landing locations 601A-G within the geographic area 400 according to example implementations of the present disclosure. The geographic area 400 can include a plurality of landing locations 601A-G. The geographic area 600 can be an urban environment.

Landing locations 601A-G can be positioned throughout the geographic area 600 and include existing infrastructure (e.g., vertiports, charging stations etc.) of a transportation service, third-party infrastructure (e.g., airports, private helipad, etc.) or public areas (e.g., parks, waterways, highways, etc.). For instance, landing location 601A can include a vertiport owned or operated by a service whereas landing location 601C can include a private airport.

The geographic area 400 can be surveyed to identify the landing locations 601A-G within the geographic area 400. The available landing locations 601A-G can be added to a complex or simple data structure that can be accessed to generate/assign to routes, select contingency landing locations, etc. In some implementations, a robust list of all available landing locations can be determined prior to flight operations in the geographic area 400. In other implementations, new landing locations may be discovered in-flight as the aircraft operates in the geographic area 400.

The landing locations 601A-G can be utilized for various purposes. For instance, certain landing locations 601A-G can be utilized as aerial facilities for providing transportation services. This can include vertiports that can be used to transport riders via an aircraft through the geographic area 400.

Additionally, or alternatively, the landing locations 601A-G can be utilized as contingency landing locations. For instance, a landing location 601E may include an open area on a rooftop with substantial area for an aircraft to perform a vertical landing but may lack the full infrastructure to serve as a primary vertiport for a transportation service. As such, the landing location 601E can be used for a contingency landing location, where appropriate.

Based on the geographic area 400, the contingency planning system 303 can access data indicative of a plurality of contingency landing locations. For example, given the geographic area 400 in which an aircraft will be operating along a route 401 (e.g., a geographic id associated therewith), the contingency planning system 303 can search a database to access the landing location data 307. The contingency planning system 303 can process the landing location data 307 to determine what landing locations are available and appropriate as contingency landing locations for the route 401. As further described below, the contingency planning system 303 can filter the landing location data 307 to identify candidate contingency locations in the geographic area 400 and then match one or more contingency locations to each route segment of a route. This information can be utilized to generate a contingency landing plan 311 for an aircraft, prior to the aircraft traversing the route.

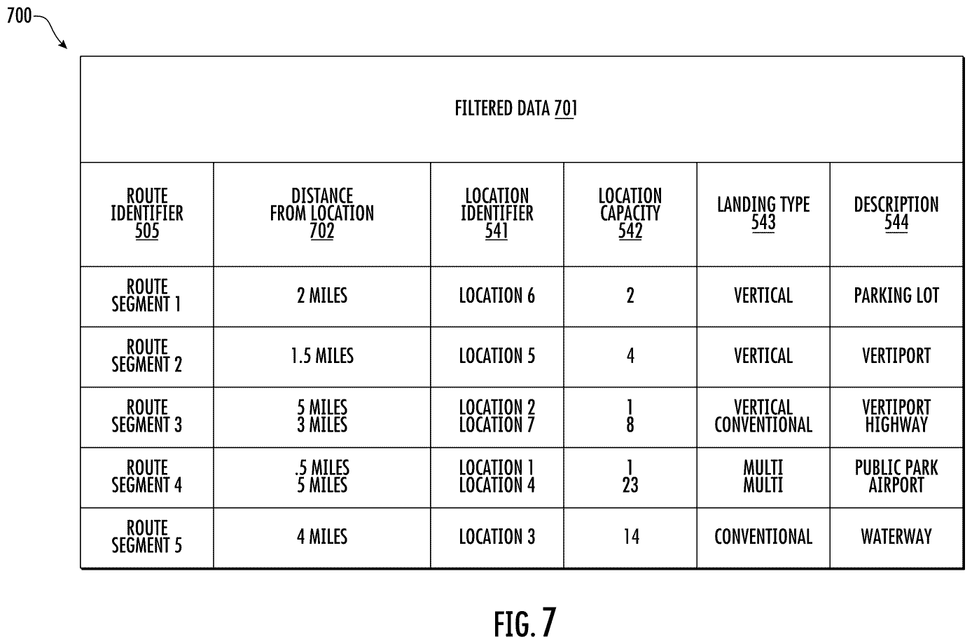

The contingency planning system 303 can filter landing locations 601A-G in a geographic area 400 prior to assigning them to a route segment 402A-C. For example, FIG. 7 depicts an example data structure 700 that includes filtered data 701 according to example implementations of the present disclosure. The filtered data 701 can include a subset of the landing location data 307, which has been filtered for the route 401. The data structure 700 can be populated or otherwise created by the contingency planning system 303 for computing a contingency landing plan 311 or computing updated contingency landing plan 312. The data structure 700 can be stored within the contingency planning system 303 and transmitted to a system on-board the aircraft. In some implementations, the data structure 700 may be stored on-board an aircraft.

The contingency planning system 303 can filter the landing location data 307 to identify candidate contingency locations based on a variety of criteria associated with the route data 305 or the aircraft data 306. The filtered data 701 can include all available landing locations in a geographic area which satisfy the criteria.

The contingency planning system 303 can compute candidate contingency locations based on a deviation distance from the route segments 402A-C of the route 401 to landing locations 601A-G. For example, the route identifier data 505 can indicate the respective route segments 402A-C within a route. Landing locations 601A-G further away from the route segments 402A-C may be filtered out of the contingency landing locations that are eligible for assignment for the route. By way of example, a threshold distance of X miles may be used as criteria to filter landing locations 601A-G to include only landing locations 601 A-G within X miles of the route segment. The threshold distance can be a predetermined distance based on contingency capabilities of the aircraft or dynamically determined based on contingency event data 302.

In some implementations, landing locations 601A-G can be filtered based on the type of landing maneuver capable of being performed by the aircraft. For instance, as described herein, aircraft data 306 can indicate that an aircraft can perform vertical landings, conventional landings, or both. The contingency planning system 303 can filter landing locations 601A-G based on the landing type 543 supported by the location. Landing locations 601A-G can accommodate landing types 543 such as vertical landings depicted as “vertical”, conventional landings depicted as “conventional”, or both depicted as “multi”. Filtering all available landing locations 601A-G in a geographic area 400 based on the landing type 543 can allow only contingency landing locations which are compatible with an aircraft to be considered as an option. Furthermore, filtering the landing locations 601A-G can preserve computing resources of the contingency planning system 303 by avoiding the processing of candidates that cannot support the landing of a particular aircraft.

In some implementations, other metadata associated with a landing location 601A-G can be used to identify candidate contingency landing locations. For instance, a description 544 of the landing location 601A-G can provide additional information to the contingency planning system 303 when computing whether to assign a particular landing location 601A-G to a route segment as a contingency landing location. The description 544 can include any type of metadata associated with a contingency landing location. In some examples, the description 544 can be updated in real-time to dynamically provide metadata associated with the contingency landing location. This can include updates to occupancy (e.g., based on an event), traffic, etc.

In an example, the description 544 can indicate that a landing location is a public park. Public parks, while satisfying space requirements for accommodating the landing of aircraft, may be densely populated with people during certain time intervals. This additional information can result in the contingency planning system 303 computing an alternative contingency landing location despite the public park satisfying all other criteria and having a closer distance to the route segment than any other landing location.

In some implementations, the landing locations 601A-G can be filtered based on capacity and time. For instance, the landing location data 307 may indicate the capacity of a particular landing location for each of a plurality of time intervals throughout a day. The route data 305 can indicate the estimated timeframe that an aircraft may be traversing a particular route segment. Using the timeframes from the route data 305, the contingency planning system 303 can predict which landing locations 601A-G will have enough capacity to accommodate the aircraft during the respective timeframes. Landing locations 601A-G that cannot accommodate the aircraft can be filtered out as candidate contingency landing locations.

The contingency planning system 303 can compute a contingency landing plan 311 for an aircraft based on the route data 305 and the data indicative of the plurality of contingency landing locations (e.g., the filtered data 701). The contingency planning system 303 can assign landing locations 601A-G to a route 400 as contingency landing locations and saved in a data structure representing the contingency landing plan 311. The contingency landing locations can be selected based on considerations such as proximity (e.g., threshold distance) from a route segment 401A-C, the type landing maneuver (e.g., vertical, conventional etc.) to be performed by the aircraft, or other logistics considerations.

As shown in FIG. 7, the contingency planning system 303 can associate contingency landing locations with certain route segments within data structure 700. For example, the location identifier 541 can identify a landing location 601A-G that is being assigned to a particular route segment 402A-C as a particular contingency landing location.

In some examples, more than one contingency landing location can be associated with a route segment. Route segments 3 and 4 depict multiple associated contingency landing locations. Multiple contingency landing locations associated with a route segment can indicate more than one contingency landing location option for a route segment. For instance, filtered contingency landing locations can be ranked based on other factors such as the available capacity (e.g., location capacity 542), the type of landing maneuver to be performed by the aircraft (e.g., landing type), or metadata associated with the contingency landing location (e.g., description 544).

By way of example, route segment 4 can be associated with location 1 and 4 (e.g., contingency landing locations), based on the distance between the route segment 4 and locations 1 and 4. The contingency planning system 303 can determine, based on location capacity 542 associated with location 1, that an alternative location (e.g., location 4) may need to be computed based on location 1 having capacity to accommodate only 1 one more aircraft. As such, locations 1 and 4 may both be associated with route segment 4.

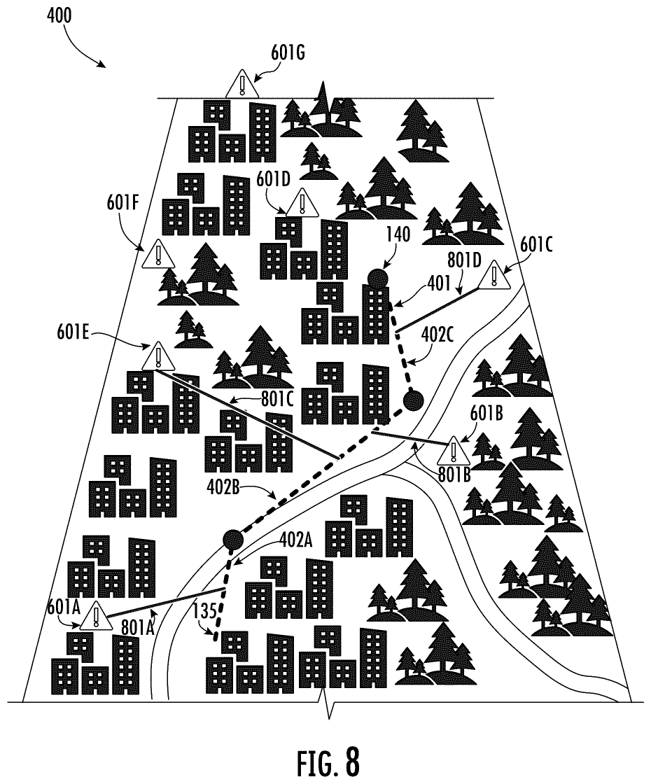

FIG. 8 depicts example contingency landing locations 801A-D assignments for route segments 401A-C along a route 401 within geographic area 400 according to example implementations of the present disclosure. The contingency landing assignments 801A-D can indicate alternative options for the aircraft in the event the aircraft needs to land while navigating a long a particular route segment 401A-C. The contingency planning system 303 can compute contingency landing assignments 801A-D for each aircraft in a fleet of aircraft and/or multiple fleets of aircraft across other VTOL operators such that each aircraft is assigned a contingency landing location at each point during a route. For example, each route segment 401A-C can include one or more contingency landing assignments 801A-D such that the aircraft has a contingency landing location at each point during the route 401.

For example, as depicted in FIG. 8, the route segment 402A can include contingency landing assignment 801A which indicates that landing location 601A is the contingency landing location where the aircraft should navigate in the event of an event that causes the aircraft to land while navigating along route segment 401A. The landing location 601A can be assigned as a contingency landing location to route segment 401A due to the proximity of the landing location 601A. The contingency planning system 303 can iteratively assign one or more contingency landing locations 601A-G to a route such that an aircraft has at least one contingency landing location 601A-G at each point (e.g., for each route segment 402A-C) throughout the route.

In some implementations, a particular route segment 401A-C can include more than one contingency landing assignments 801A-D. For instance, route segment 401B can include contingency landing assignments 801B-C indicating that landing locations 601B, 601E are assigned as contingency landing locations for route segment 402B. The contingency landing assignments 801B-C can indicate contingency landing locations which accommodate different landing types. For instance, contingency landing assignment 801B can include landing location 601B, which may only accommodate conventional landings while contingency landing assignment 801C can include landing location 601, which may accommodate only vertical landings. The plurality of contingency landing assignments 801B-C can, thus, provide the aircraft with multiple landing options based on the circumstances.

In some implementations, the contingency planning system 303 can provisionally assign landing locations 601A-G as contingency landing locations. For instance, landing location 601C can be provisionally assigned as a contingency landing location for route segment 401C. By doing so, the contingency planning system 303 can maintain an understanding of the estimated capacity of landing location 601C during the future time frame in which the aircraft will be traversing route segment 401C. This assignment may be considered provisional because the aircraft has not yet reached route segment 401C. Thus, if needed to accommodate other aircraft, the contingency planning system 303 could change the contingency landing location for route segment 401C prior to the arriving at the route segment 401C. Once the aircraft arrives at a particular route segment, the contingency landing assignment 801D can be confirmed in real-time and will no longer be a provisional. The status of the contingency landing assignments 801A-D can be monitored and tracked by the contingency planning system 303 and updated while the aircraft is in-flight, if necessary.

Returning to FIG. 3, the contingency planning system 303 can compute a contingency landing plan 311 that indicates contingency landing locations for an aircraft assigned to a route prior to take-off or departure. The contingency landing plan 311 can assign at least one respective contingency landing location to each route segment of the plurality of route segments of the aircraft's route. For example, the contingency landing plan 311 can include the contingency landing assignments 801A-D, indicating the contingency landing locations for an aircraft traveling along route 401. The contingency landing plan 311 may also include other information associated with the contingency landing locations, such as their locations, supported landing types, available infrastructure, capacities, other information provided in the landing location data 307, etc.

The contingency landing plan 311 can be represented in any suitable data format and structure that can be transmitted and ingested by the aircraft devices 235. This can include a table, array, etc. In some implementations, the contingency landing plan 311 may include map data identifying the location of the contingency landing locations and metadata associated therewith.

The contingency planning system 303 can transmit (e.g., over one or more networks) the contingency landing plan 311 to a flight planning system 304 associated with an aircraft. The flight planning system 304 can include one or more systems on-board the aircraft. The fight planning system 304 can be configured to provide information associated with the flight operations of the aircraft. The flight planning system 304 can include a standalone system on-board the aircraft or otherwise associated with an aircraft device 235 on-board the aircraft. The flight planning system 304 can store data associated with the flight operations of the aircraft such as flight plan data 308 and contingency landing data 309.

Flight plan data 308 can include information associated with a flight plan stored in one or more data structures that include various parameters associated with performing a flight. The data structures can include structured data fields (e.g., such as an object having a class data type defined in a programming language), look-up tables, lists, trees, arrays, etc. The parameters stored within the data structure can include a route, aircraft maneuvers (e.g., take-off maneuver, landing maneuver, hover maneuver, cruise maneuver), altitudes, environmental conditions, noise constraints, speeds, etc. at an origin, destination, or therebetween for the associated flight. Flight plan data 308 can include related times (e.g., take-off/landing times), locations (e.g., departure/destination locations, waypoints), or other information associated with the flight.

Contingency landing data 309 can include data associated with the contingency landing plan 311 computed by the contingency planning system 303. The contingency landing data 309 can store the contingency landing plan 311 in a data structure which allows the aerial vehicle device 235 to render audio/visual queues which identify the contingency landing assigned to the aircraft as it navigates along the route. For example, the aerial vehicle device 235 can include one or more user interfaces 310 for displaying or presenting flight plan data 308 and contingency landing data 309 to the aircraft operator or pilot. In some examples, one or more user interface elements can be displayed on the user interface 310 prior to take-off to indicate the contingency landing plan 311 for the aircraft during the route.

The capacity of landing locations and the assignments of aircraft thereto can be tracked in real-time. For example, FIG. 5B depicts example data structures 551 and 552 for respective landing locations. The data structures 551, 552 can be aircraft registries that indicate the aircraft assigned (including provisionally assigned) to the associated landing location at a given time. As shown in FIG. 5B, the aircraft registries can indicate the estimated timeframe for which the landing location is assigned to the aircraft as a contingency landing location.

The contingency planning system 303 an update the data structures 551, 552 as the aircraft traverse their routes within the geographic area. For example, when a first aircraft is traveling along a route segment for which a first landing location is assigned as a contingency landing location, the data structure 551 can list the first aircraft in its aircraft registry. This can be reflected in the capacity of the first landing location.

When the first aircraft completes the route segment (and begins traversing the subsequent route segment), the first aircraft can be released from the data structure 551 (e.g., the aircraft registry) such that the first aircraft is no longer associated with the landing location. This can be reflected in the capacity of the landing location. For example, the capacity of the landing location can be updated to indicated increased capacity for aircraft when the first aircraft is released from the data structure 551, the aircraft registry.

After take-off, the contingency planning system 303 may update the contingency landing plan 311 while the aircraft is in-flight. To do so, the contingency planning system 303 can access vehicle operations data 301 from one or systems over a network (e.g., network 250).

Vehicle operations data 301 can include information related to aircraft performing a transportation service in a geographic area. This can include the location of the aircraft, charge/fuel levels, attitude, payload, progress along a route, or other operating parameters of a flight. Vehicle operations data 301 can also indicate real-time status information associated with other aircraft such as whether other aircraft will arrive early, on-time, late, delayed, or any other data associated with the operations of other aircraft.

The vehicle operations data 301 can be provided via the aircraft devices 235 of the aircraft or from another computing system or service that is monitoring the aircraft. The vehicles operations data 301 can be provided to, requested by, and/or stored in a database that is accessible to the contingency planning system 303.

The vehicle operations data 301 can include data indicative of ongoing flight operations as well as a change in flight operations. This can include, for example, a change in flight operations for a first aircraft associated with aircraft devices 235 or a change in flight operations of other aircraft such as a second, different aircraft that is in-flight within the geographic area.

The change in flight operations can include, for example, route deviations for aircraft operating within the geographic area 400. The contingency planning system 303 can compute the updated contingency landing plan 312 based on the route deviations.

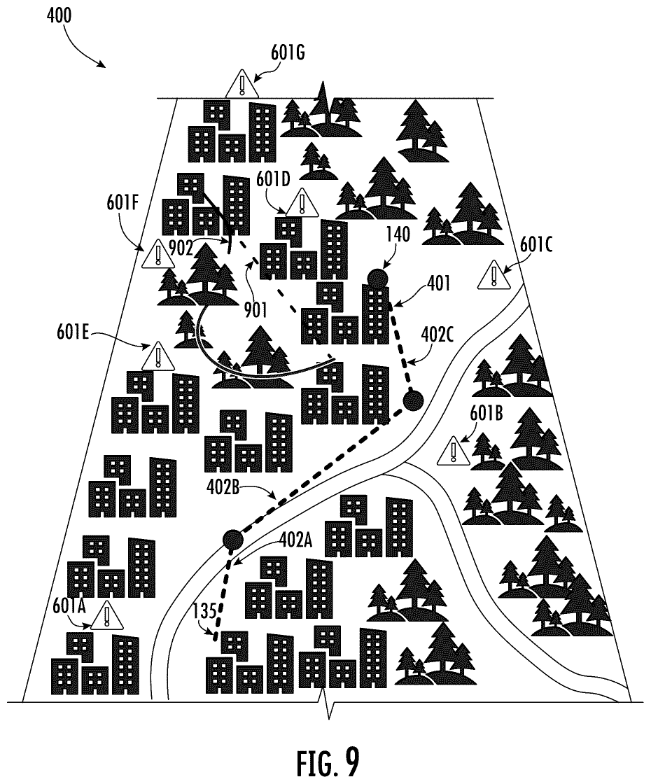

By way of example, FIG. 9 depicts an example route 901 of an aircraft within geographic area 400 according to example implementations of the present disclosure. The route 401 can be associated with a first aircraft that is flying within the geographic area 400. The route 901 can be associated with a second aircraft that is flying within the geographic area 400. The second aircraft may initially fly along route 901 but deviate from route 901 along route deviation 902. The location of the second aircraft can be tracked and provided in the vehicle operations data 301, which can then be processed by the contingency planning system 303. For instance, the contingency planning system 303 can process the vehicle operations data 301 to determine that the second aircraft has deviated from its initial route.

The contingency planning system 303 can compute an updated contingency landing plan 312 for the first aircraft based on the change in the flight operations of the second aircraft. The updated contingency landing plan 312 can include at least one change in the contingency landing locations assigned to the first aircraft for the route 401.

By way of example, as shown in FIG. 9, the route 401 can include a plurality of route segments 401A-C for a first aircraft. The first aircraft and the second aircraft can navigate through the geographic area concurrently. For instance, the first aircraft and second aircraft can depart from respective departure locations at the same time. In some examples, the plurality of route segments 401A-C of the first aircraft can overlap with the nearby route 901 of the second aircraft. For example, the first and second aircraft can fly at different altitudes while navigating through the geographic area 400.

The contingency planning system 303 can determine the route deviation 902 of the second aircraft from route 901 creates a conflict for one or more contingency landing assignments 801A-D. For example, the route deviation 902 can lead the second aircraft toward a landing location 601E. Landing location 601E may have been included in the initial contingency landing plan 311 for the first aircraft to provide a vertical contingency landing location as the first aircraft flies along route segment 401B. The contingency planning system 303 can compute, based on vehicle operations data 301, the proximity of the second aircraft to the landing location 601E. Moreover, the contingency planning system 303 can determine that the second aircraft can only perform vertical landings.

Based on the route deviation 902 of the second aircraft, the contingency planning system 303 can compute an updated contingency landing plan 312 for the first aircraft. For instance, the contingency planning system 303 can determine that given the capacity of landing location 601E, the landing location 610E cannot be assigned as a contingency landing location for both the first and the second aircrafts during concurrent timeframes. Given the route deviation 902, the proximity of the second aircraft to the landing location 601E, and the vertical-only landing capability of the second aircraft, the contingency planning system 303 may determine that it is preferable to re-assign the landing location 610E from the first aircraft to the second aircraft as a contingency landing location.

As a result, the contingency planning system 303 can reassign other contingency landing locations 601A-G to the first aircraft. For example, the route segment 401B can be assigned landing location 601D as a contingency landing location. The contingency planning system 303 can compute an updated contingency landing plan 312 including one or more updated contingency landing assignments for the route 401 of the first aircraft. The contingency planning system 303 can compute an updated contingency landing plan for the second aircraft, to include the landing location 601E. The updated contingency landing plans 312 can be computed and provided to the first and second aircraft, while they are in-flight. In this way, the first aircraft and the second aircraft are assigned an available contingency landing locations that can accommodate the first and second aircraft respectively.

The contingency planning system 303 can transmit the updated contingency landing plan 312 to the flight planning system 304 of the first aircraft. The updated contingency landing plan 312 can update the user interface 310 to reflect the updated contingency landing plan 312. For example, the user interface 310 can be updated to indicate landing location 601D as a contingency landing location for the route segment 402B.

Returning to FIG. 3, the contingency computing system 303 can also, or alternatively, accessing contingency event data 302. The contingency event data 302 can include information related to a contingency event associated with one or more aircraft or the geographic area in which the aircraft are operating. Examples of contingency event data 302 can include information indicating that an aircraft has changed flight operations which may prevent the aircraft from reaching a predetermined destination (e.g., inclement weather, etc.) or which may impact or reduce the quality of flight operations.

Contingency event data 302 can include information indicating a national emergency in which flights in a geographic area must land immediately. Contingency event data 302 can be indicative of a passenger emergency onboard an aircraft.

Contingency event data 302 can be accessed from the airspace system 220, third party system 215, or any other system. In some implementations, the contingency event data 302 can be accessed from aircraft devices 235. This may occur, for example, in the event of a passenger emergency onboard the aircraft.

In some implementations, the contingency event data 302 can be associated with a predicted landing maneuver of the aircraft. For example, severe weather may reduce the ability of an aircraft to perform a particular maneuver such as a vertical landing, such that it would be preferable for the aircraft to perform a conventional landing.

The contingency planning system 303 can compute an updated contingency landing plan 312 for an aircraft based on the contingency event data 302. By way of example, an aircraft operator or pilot associated with a first aircraft may interact with one or more aircraft devices 235 on-board the first aircraft to provide user input indicating that a passenger on-board the first aircraft is experiencing a medical emergency and requires medical attention. The contingency planning system 303 can access the contingency event data 302 indicating the execution of at least a portion of the contingency landing plan 311 by the first aircraft whereby the first aircraft lands at a vertiport near a hospital. A second aircraft operating in the geographic region, prior to take-off, may have also been assigned to the vertiport near the hospital. However, due to the first aircraft landing at the vertiport near the hospital and occupying the landing location for an extended duration, the second aircraft may require an updated contingency landing plan 312 based on the first aircraft occupying the initial contingency landing location assignment. The contingency planning system 303 can compute an updated contingency landing plan 312 for the second aircraft and transmit the updated contingency landing plan 312 to the second aircraft.

In another example, contingency event data 302 can indicate a first aircraft is experiencing certain environmental conditions which prevent the aircraft from executing a vertical landing. Prior to take-off, a contingency landing plan 311 for the aircraft may have indicated one or more contingency landing locations that can only accommodate a vertical landing (e.g., vertiports, etc.) based on aircraft identifier data 306 indicating the aircraft is capable of vertical and conventional landings. However, based on the contingency event data 302 indicating change in circumstances, the contingency planning system 303 can compute an updated contingency landing plan 312 including contingency landing locations that accommodate conventional landings.

In some examples, computing an updated contingency landing plan 312 for a first aircraft can cause the contingency planning system 303 to compute updated contingency landing plans 312 for other aircraft. The contingency planning system 303 can iteratively compute contingency landing plans 312 as the aircraft fleet operates within the geographic area 400. For example, the contingency planning system 303 may compute updated contingency landing plans 312 for a plurality of aircraft to ensure that contingency landing locations are proportionately assigned across a fleet of aircraft, given the change in contingency landing assignments for the first aircraft.

The contingency planning system 303 can utilize vehicle operations data 301 and contingency event data 302 individually or in combination to compute and updated contingency landing plans 312 for aircraft.

In some examples, the updated contingency landing plan 312 can include an updated route for an aircraft. For instance, the contingency planning system 303 may determine that contingency landing locations which satisfy criteria to be assigned to an aircraft for a particular route will be unavailable during the period where aircraft is assigned to the contingency landing location. As such the contingency planning system 303 can compute an updated contingency landing plan 312 as well as updated route data. The updated route data can include one or more new route segments which indicate an updated flight path from the current position of the aircraft to a destination location. For instance, the updated route data can cause the aircraft to fly within a threshold distance of contingency landing locations which can accommodate the aircraft at each point during flight.

In some implementations, the contingency planning system 303 can communicate with one or more other aircraft or personnel at a contingency landing location to increase the landing capacity of contingency landing location. By way of example, the contingency planning system 303 can determine that a particular contingency landing location assignment for an aircraft within a fleet of aircraft would be more efficient for proportionately assigning contingency landing locations across the fleet of aircraft. The contingency planning system 303 can determine that the particular contingency landing location does not have available capacity based on vehicle operations data 301, landing data 307, location registries, or by communicating with computing devices associated with the contingency landing locations (e.g., aerial facility device 240, facility operator user device 245, etc.). Based on determining the contingency landing location does not have available capacity, the contingency planning system 303 can communicate over one or more networks to request that one or more aircraft vacate a landing location such that the particular landing location can be assigned to the aircraft as a contingency.

In another example, the contingency planning system 303 can communicate with one or more other aircraft or personnel at a landing location to 601A-G to delay a departure time or arrive by time of aircraft. By way of example, the contingency planning system 303 can determine that a throughput of the each of the landing locations 601A-G has been reached or exceeded based on an increased number of flights within the geographic region 400. For instance, particular contingency landing location assignments for aircraft across multiple VTOL operators may limit the number of alternative contingency landing locations available to be reassign to a route segment that is impacted by events depicted by vehicle operations data 301, contingency event data 302, etc.

In particular, the contingency planning system 303 may predict that there will be no alternative contingency landing locations which have available capacity during a period of time based on vehicle operations data 301, landing data 307, location registries, or by communicating with computing devices associated with the contingency landing locations (e.g., aerial facility device 240, facility operator user device 245, etc.). Accordingly, the contingency planning system 303 may resolve conflicts in assignments by delaying a departure time for aircraft prior to take-off or delaying an arrive by time of aircraft in-flight. Delaying an arrive by time may include increase route segments of a route, executing flight-holding patterns, or any other mechanisms which extend the time of arrival for aircraft.

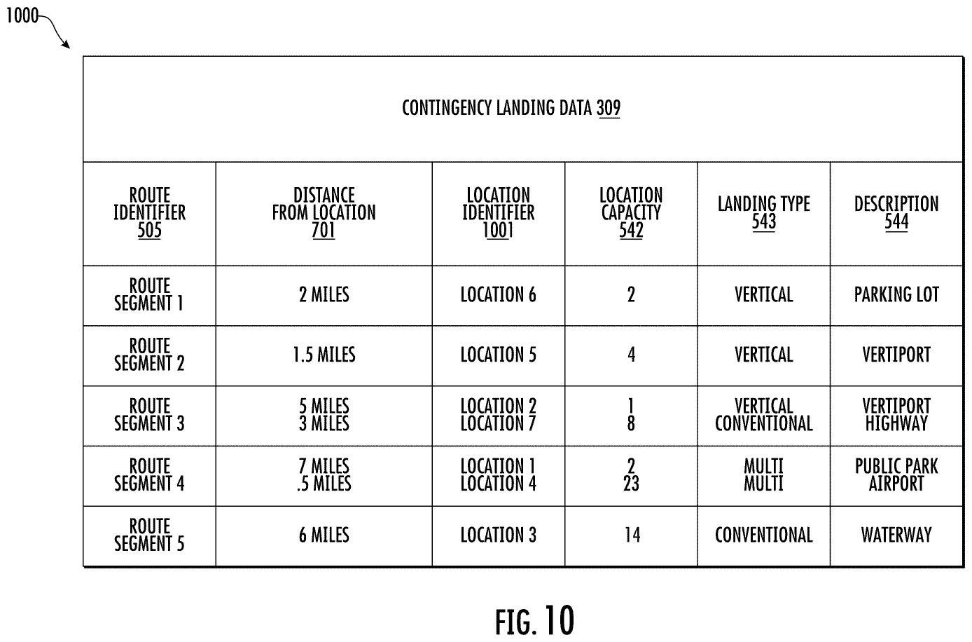

Contingency landing data 309 stored on-board an aircraft can be computed based on an updated contingency landing plan 312. FIG. 10 depicts an example data structure 1000 that includes contingency landing data 309 according to example implementations of the present disclosure. The example data structure 1000 depicts contingency landing data 309 which has been updated based on an updated contingency landing plan 312.

The example data structure 1000 can be stored on a computing system on-board the aircraft. For instance, the contingency planning system 303 can transmit the updated contingency landing plan 312 to the flight planning system 304 and store the updated contingency landing plan 312 in the example data structure 1000. In other examples, the example data structure 1000 can be stored within data storage of the contingency planning system 303.

The contingency landing data 309 can be updated based on an updated contingency landing plan 312 computed by the contingency planning system 303. For example, the contingency planning system 303 can compute an updated continency landing plan 312 based on vehicle operations data 301 indicating one or more conflicts of contingency landing assignments and/or contingency event data 302, as described herein. The data structure 1000 can be updated accordingly.

For example, the data structure 1000 can populate an updated location identifier 1001 field indicating an update to one or more contingency landing assignments 801A-D. While examples herein describe the updated location identifier 1001 as a field, the present disclosure is not limited to such an embodiment. The updated location identifier 1001 can include any data attribute such as an object, nested object, array, etc. The updated contingency landing plan 312 can create and/or populate the updated location identifier 1001 indicating the contingency landing assignments 801A-D which have been updated by the contingency planning system.

The updated location identifier 1001 can overwrite or nullify the location identifier 541 values. For example, the location identifier 541 can indicate a contingency landing plan 311 (e.g., provisional assignment), or a previous iteration of an updated contingency landing plan 312. When an updated contingency landing plan 312 has been computed by the contingency planning system 303, the updated location identifier 1001 can update the data structure 1000 to reflect the updated assignments.

The flight planning system 304 can access the contingency landing data 309 which includes the updated location identifier 1001 to update one or more user interfaces 310 on-board the aircraft. For example, the contingency landing data 309 including the updated location identifier can modify one or more user interfaces to display or otherwise notify the aircraft operator of the change in contingency landing assignments 801A-D in real-time while the aircraft is in-flight.

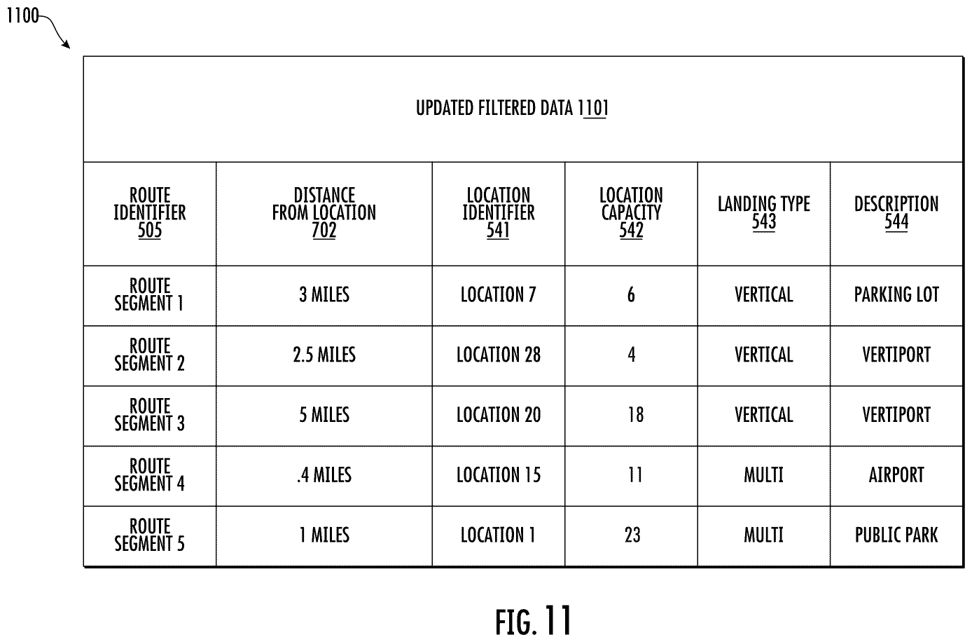

The landing location data 307 can be continuously filtered for respective aircraft and routes as the aircraft fleet operates throughout a day. FIG. 11 depicts an example data structure 1100 including updated filtered data 1101 according to example embodiments of the present disclosure. The example data structure 1100 (and its associated data) can be stored in a computing system associated with an aircraft. For instance, the data structure 1100 can be stored in a storage system within the contingency planning system 303. This can allow the contingency planning system 303 to generate updated contingency landing plans 312 for aircraft in real-time based on updated information.

The data structure 1100 can filter all available contingency landing locations within a geographic area based on one or more real-time parameters associated with an aircraft. For instance, as aircraft traverses their various assigned routes, the example data structure 1100 can filter landing locations based on any updated capacity estimations for the respective landing locations.

The data structure 1100 can filter all available contingency landing locations based on the capacity of the location to accommodate the aircraft. For instance, the contingency planning system 303 can access vehicle operations data 301 indicating itinerary information for other aircraft operating in the geographic area. In some examples, the contingency planning system 303 can access data from aerial facility devices 240 or facility operator user device 245 indicating real-time capacity data or other circumstances (e.g., closed FATOs) at a particular location. The contingency planning system 303 can access any data from any system or device within the networked computing ecosystem 200 to filter the contingency landing locations within a geographic area. Based on these inputs, the contingency planning system 303 can filter the contingency landing locations to include only locations which will have capacity while the aircraft traveling along a particular route segment. For instance, the contingency planning system 303, based on input data, can predict available capacity contingency landing locations and filter all contingency landing locations in a geographic area based on the prediction.

In some implementations, the updated filtered data 1101 can be based on changes in circumstances (e.g., closed runway) that affect the landing maneuvers. For instance, data structure 1100 depicts contingency landing data 309 filtered based on contingency landing locations landing type 543 indicating the landing location can accommodate only vertical landings, due to an error with the runaway of the landing location.

In some examples, the contingency planning system 303 can filter contingency landing locations based on the description 544 (e.g., metadata) associated with the location. By way of example, the contingency planning system 303 can determine that an otherwise candidate contingency landing location to be assigned to a route segment is a parking lot near a shopping center based on the description 544. The contingency planning system 303 can determine the parking lot is not suitable to be assigned as contingency landing location based on the aircraft itinerary indicating the aircraft would be assigned the parking lot during the time of an event that has been delayed due to weather such as, a concert, parade, etc. The contingency planning system 303 can predict an increased number of cars parked in the parking lot which will prevent the aircraft from landing due to the delay. In response, the contingency planning system 303 can further filter out contingency landing locations which meet the description 544 of a parking lot.

FIG. 12 depicts an example computing ecosystem according to example implementations of the present disclosure. FIG. 12 depicts a block diagram illustrating an example networked ecosystem 1200 for coordination of contingency planning across a plurality of VTOL operators 1205 and other aircraft entities. Other aircraft entities may include independent pilots, aircrafts associated with other industries (e.g., freight, tourism, etc.), and the like. Multiple network-connected systems can cooperatively interact within ecosystem 1200 to provide contingency planning services for the plurality of VTOL operators 1205. As shown, ecosystem 1200 may include a distributed computing system with a plurality of different participating systems/devices communicatively connected over one or more networks 250. While examples herein describe a distributed computing system, the present disclosure is not limited to such embodiment, and the computing system may be centralized (e.g., by a regulator, other third-party entity, etc.) or decentralized across the multiple VTOL operators 1205.

In an embodiment, the VTOL operators 1205 may be associated with one or more transportation platform systems such as, for example, the aerial transportation platform (ATP) systems 205 and one or more ground transportation platform (GTP) systems 210. The ecosystem 200 can additionally include the third-party provider systems 215, the airspace systems 220, user devices 225, the ground vehicle devices 230, the aircraft devices 235, the aerial facility devices 240, or the facility operator user devices 245 (not shown) as described in FIG. 2.

Each of the systems or devices can communicate over one or more wireless or wired networks 250. Networks 250 can include one or more types of networks including telecommunications networks, internet, private networks, or other networks, as further described herein.

The systems and devices of ecosystem 1200 can include a plurality of software applications operating on the respective systems and devices. This can create an ecosystem of applications for providing and coordinating contingency planning operations, as further described herein.

The resource operator 1210 can include computing systems or computing devices associated with a representative of one or more resources available to the transportation service. Resources may include the airspace structures and/or supporting ground infrastructure that make up the operational environment in which aircraft operations (e.g., transportation services) are planned and conducted. By way of example, the airspace structures may utilize various shared resources such as waypoint-centric (e.g., point-based) resources that may include vertiports, vertiport pads, corridor/track entry, corridor/track exit points, route/track intersection or merge points, and arrival or departure procedure fixes, and others airspace-centric (volume-based) resources.

The resource operator 1210 may be responsible for operating (e.g., managing) one or more resources. By way of example, a resource operator 1210 may include a vertiport operator in which the resource is a vertiport serving as a landing location. The resource operator 1210 may perform functions including, but not limited to: establishing the baseline resource definition(s) for the vertiport with resource stakeholders (e.g., VTOL operators 1205, resource authority 1215, etc.); establishing appropriate resource authorities 1215 for the vertiport; determining and updating the current and/or forecast resource status for the vertiport as it operates; determining and/or updating the current and forecasted resource capacities for the vertiport as it operates; providing mechanisms to discover the resource definition(s) (e.g., landing location data 307, etc.) for the vertiport as it operates, etc. In an embodiment, a VTOL operator 1205 may also be a resource operator 1210.

The resource authority 1215 can include computing systems or devices associated with a public or private entity chartered for the purpose of defining requirements for establishing the resources of the transportation service, defining potential certification (as required) and maintenance requirements, etc. For example, the resource authority 1215 can include devices or computing systems associated with a regulator or a designated entity. In an embodiment, the resource authority 1215 may also have the authority to amend the status and capacities of specific resources available to the transportation service.

The resource information service (RIS) 1220 may include systems or computing devices which provide discovery capabilities for the VTOL operators 105, resource operators 1210, resource authority 1215, etc., for identifying the current and forecasted status and capacities of shared transportation service resources. For example, various resource operators 1210 may include systems or devices which communicate and process data using various communication protocols, data structures, etc. The RIS 1220 may include software configured to standardize the dynamic status and capacity data of each shared resource (e.g., operated by the various resource operators 1210) and expose the data across all resource operators 1210, VTOL operators 1205, etc. In this manner, the RIS 1220 may provide resource definitions which define a standardized format of resource status and resource capacity data (e.g., landing location data 307, etc.) to a demand capacity balancing (DCM) system 1225 to coordinate demand and capacity for contingency landing locations across the plurality of VTOL operators 1205.

For example, a data synchronization service (DSS) 1230 may include computing systems or devices which enables information exchange among the VTOL operators 1205 and the resource operators 1210. For example, the DSS 1230 may receive resource references indicating the standardized data (e.g., landing location data 307, etc.) and allow entities within the transportation service or other entities to access relevant information that may be owned by another entity, including operational intent details, constrained resource details, and constrained resource status and capacities. In an embodiment, the DSS 1230 may also support the discovery of information necessary to generate a common operating picture.

By way of example, the DSS 1230 may receive resource references indicating all available landing locations (e.g., resources) within a geographic region. The DSS 1230, based on a landing location resource definition, may standardize the resource references to generate landing location data 307 and may expose (e.g., via APIs, etc.) the standardized landing location data 307 to the VTOL operators 1205 and the resource operators 1210 to provide a shared perspective of available landing location across the transportation service and current statuses of each landing location. For instance, the DSS 1230 may receive updates on the resource status and capacity from the resource operators 1210. Moreover, in the event of a new resource, the RIS 1220 may provide the DSS 1230 with a new resource references to allow the new resource to be shared across the transportation service.

In embodiment, the DSS 1230 may implement data access control for the standardized data by implementing role-based data access to ensure secure data exchange among VTOL operators 1205 and resource operators 1210. For example, the DCB 1225 may implement roles such as read only operational intent, while an operation intent management (OIM) 1240 system can write (submit and update) operational intent to the DSS 1230. An example of operational intent may include a flight intent (e.g., a planned route, flight planning, etc.) indicating that a VTOL operator 1205 has planned a flight operation and, as such, necessitates capacity usage of one or more resources of the transportation system. Operational intent may be used by the DBC 1225 to more accurately predict future positions of aircraft, capacity usage of aircraft, etc. For instance, the DSS 1230 may concatenate resources such as landing locations, with a status, capacity, and operational intent providing a more complete picture of a current and predicted future capacity of each landing location within the transportation service. Moreover, in this manner, the DSS 1230 can ensure information is consistent across each entity (e.g., VTOL operators 1205, resource operators 1210, etc.) and orchestrate synchronization in a centralized manner.

However, sharing resources and data across the plurality of VTOL operators 1205 may create conflicts where the demand for resources such as contingency landing locations exceed available capacity. In order to resolve potential conflicts, the demand capacity balancing (DCM) system 1225 may be implemented. The DCB 1225 can include computing systems or devices configured to identify imbalances between the demand and capacity of resources utilized by a transportation service (e.g., airspace volumes, waypoints, vertiports, etc.) and prevent disallowed demand capacity imbalances from occurring. For example, the DCB 1225 may include computer logic configured to balance demand on a resource against the capacity of the resource. For demand and capacity on a resource (e.g., landing locations, etc.) to become imbalanced, demand for the resource must exceed the capacity of the resource.

By way of example, the RIS 1220 may provide resource definitions for landing locations, status updates, and capacity updates to the DCB 1225. The DCB 1225 may utilize the resource definitions to query and receive real-time updates from the DSS 1230 indicating the current capacity for landing locations. The DCM 1230 may also receive operational intent data (e.g., flight plan data 308, route data 305, etc.) from the OIM 1240. For instance, the VTOL operators 1205 may provide flight planning operations to the OIM 1240 to verify and/or reserve appropriate resources for a planned flight.

The DCB 1225 may estimate demand for capacity constrained resources such as contingency landing locations. To do so, the DCB 1225 may identify intersections between operation intent details (4DTs) of operations and resource boundaries in 4-dimensions (space and time). 4TDs or a four-dimensional trajectory is a trajectory that defines the flight path of an aircraft from one point to another in four dimensions (latitude, longitude, altitude and time. For example, the 4DT may indicate predicted position of aircraft in-flight and determine whether demand for a contingency landing location along the flight path will be a constrained resource based on analyzing all 4DTs across the plurality of VTOL operators 1205 within the transportation system.

In an embodiment, the DCM 1225 may also receive operational intent from other aircraft entities not included in the transportation service. For instance, the OIM 1235 of other aircrafts may also provide operational intent to the DCM 1225. Such data may be used to assign contingency landing locations in real-time for the plurality of VTOL operators 1205, other aircraft entities, etc. as the aircraft travels along respective routes while balancing the demand and capacity for the contingency landing locations. In some embodiments, the OIM 1235 of other aircraft may also be associated with VTOL operators 1205 when conducting contingency planning in a decentralized manner as further described herein.

In an embodiment, conflicts may arise where competing demand for a resource such as landing locations may not be easily resolved. In an embodiment, resource authorities 1215 may provide requirements for which operations should take priority. In such prioritizations, a hierarchy of priority levels may be implemented. For instance, aircraft transporting passengers may be prioritized over aircraft carry cargo or freight. In another embodiment, the DCB 1225 may implement policies or procedures to resolve conflicts. Example policies may include, but are not limited to a “first come, first serve” basis.

In an embodiment, aircraft may deviate from a planned route (e.g., based on contingency event data 302, vehicle operations data 301, etc.). A conformance monitoring (CM) system 1250 may receive data indicating the aircraft position in flight to determine whether any deviations occur. For instance, the CM 1250 may receive the operational intent from the OIM 1240 indicating the planned route (e.g., route data 305) and vehicle operations data 301 indicating a position of the aircraft relative to the route data 305.

In the event of a deviation, alerts may be sent to the OIM 1240 to indicate a deviation has occurred and update the operational intent (e.g., re-route intent, emergency landing intent, etc.). For instance, the RIS 1220 may include performance bounds which indicate threshold tolerance levels for resources such as landing locations. By way of example, the RIS may include a location capacity 542 as a performance bound to the resource definition of landing location data 307 indicating the maximum capacity of a particular landing location.

This information may be used by the CM 1250 to determine whether a position of an aircraft may cause a contingency landing location to be reassigned to an aircraft based on a deviation and determine whether the additional assignment to the landing location can be accommodated. In an embodiment, the updated operational intent (e.g., deviation) may be provided to the DCB 1225 where a rebalancing may occur to ensure that other VTOL operators 1205 maintain contingency landing locations for each point along the respective routes of the various fleets of aircraft. In this manner, the contingency planning across the plurality of VTOL operators 1205 may be centralized.

In an embodiment, contingency planning may also be decentralized. For example, the data described herein generated by the RIS 1220, DCB 1225, DSS 1230 and OIM 1240 may be provided to the plurality of VTOL operators and other aircraft entities. For instance, a DCB 1245 of other aircraft entities may be provided operational intent from the OIM 1240. The DCB 1245 may include similar functionality as the DCB 1225 except that the DCB 1245 is operated independent of the computing ecosystem 1200.

In an embodiment, the DCB 1245 may be associated with the plurality of VTOL operators 1205 and other aircraft entities. By providing the DCB 1245 operational intent of all VTOL operators 1205 and other aircraft entities (e.g., based on operational intent from the OIM 1235, a common operating picture may be shared. Moreover, the DCB 1245 may estimate demand for capacity constrained resources such as contingency landing locations in a decentralized manner. For instance, based on decentralized decisions (e.g., re-assignments, delays, etc.) to identify imbalances between the demand and capacity of resources utilized by the respective VTOL operators 1205 and prevent disallowed demand capacity imbalances from occurring, updated operational intent may be provided back into the computing ecosystem via the OIM 1235, VTOL operators 1205, resource operators 1210 which are also VTOL operators 1205, etc. In this manner, each VTOL operator 1205 (e.g., or other aircraft entity) may manage contingency planning in a centralized manner while maintaining balance across the shared resources of the transportation service.

### Example User Interfaces for Presenting Recommended Contingency Landing Locations

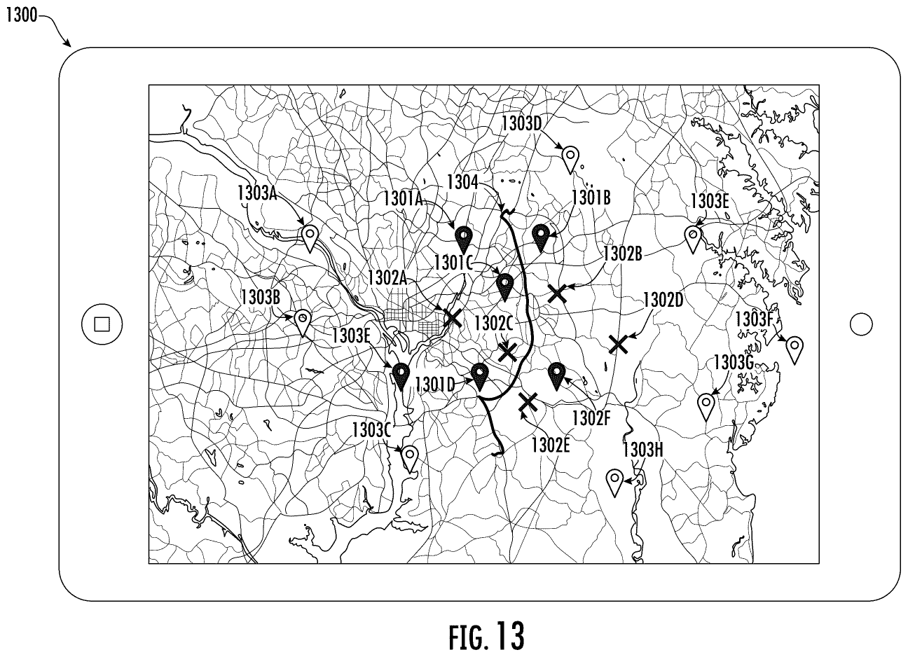

FIG. 13 depicts an example user interface according to example embodiments of the present disclosure. The example user interface 1300 can be a user interface rendered on the one or more user interfaces of the aircraft device 235 or another computing system on board the aircraft. The aircraft operator or pilot can access the user interface 1300 in-flight to view all available contingency landing locations user interface elements 1303A-H, unassigned contingency landing locations user interface elements 1302A-E and assigned contingency landing locations user interface elements 1301A-F on an interactive map of a geographic area. The user interface 1300 can include a route user interface element 1304 depicting the route assigned to the aircraft.

The example user interface 1300 can render a display of contingency landing data 309 for the aircraft operator or pilot. For instance, the user interface 1300 can provide an interactive display to the aircraft operator or pilot to more efficiently determine contingency landing assignments at each point during the flight. The aircraft operator or pilot can interact with all available contingency landing locations user interface elements 1303A-H, unassigned contingency landing locations user interface elements 1302A-E and assigned contingency landing locations user interface elements 1301A-F. For example, the aircraft operator can interact (e.g., click) with the user interface elements to display additional information or provide user input. The interactive user interface elements may each be selectable, adjustable, or interactive. Example types of interactive user interface elements may include soft buttons, menus, checkboxes, sliders, etc.

The aircraft operator can interact with the user interface 1300 to filter views of the geographic area. For instance, the aircraft operator can provide user input to filter the user interface to only include assigned contingency landing locations user interface elements 1301A-F. For instance, the assigned contingency landing locations user interface elements 1301A-F can correspond to contingency landing assignments 801A-D for the route. The user interface 1300 can display the location of the contingency landing locations assigned to the route on a map of the geographic area.

The aircraft operator or pilot can override a contingency landing location assigned to a route segment by providing user input. For instance, the contingency planning system 303 can assign contingency landing locations as recommendations for an aircraft operator. The aircraft operator can view the recommended contingency landing location assignments and determine another contingency landing location is more appropriate. By way of example, the aircraft operator can interact with the user interface 1300 and view all available contingency landing locations user interface elements 1303A-H indicating all available contingency landing locations in the geographic area. The aircraft operator can interact with one or more unassigned contingency landing locations user interface elements 1302A-E and indicate an intent to land at one of the unassigned contingency landing locations, by interacting (e.g., clicking) an unassigned contingency landing locations user interface element 1302A-E. The user input can indicate the occurrence of a contingency event. For instance, the user input of the aircraft operator can be transmitted to the ATP system 205 as contingency event data 302 indicating the aircraft is intending to divert from an assigned route to land at a contingency landing location.

In some examples, the user interface 1300 can be rendered prior to take-off. For instance, the contingency planning system 303 can compute a contingency landing plan 311 and transmit the contingency landing plan 311 to a computing system on-board the aircraft. The user interface 1300 can render a display of the contingency landing plan 311 prior to take off. In some examples, the user interface 1300 can be iteratively updated while the aircraft is in-flight. For instance, as the contingency planning system 303 computes updated contingency landing plans 312, the user interface 1300 can be iteratively updated to reflect the updated contingency landing locations assigned to the route. For instance, the available contingency landing locations user interface elements 1303A-H, unassigned contingency landing locations user interface elements 1302A-E and assigned contingency landing locations user interface elements 1301A-F can be iteratively updated to reflect the updated contingency landing plan 312.

### Example Computer-Implemented Processes and Methods

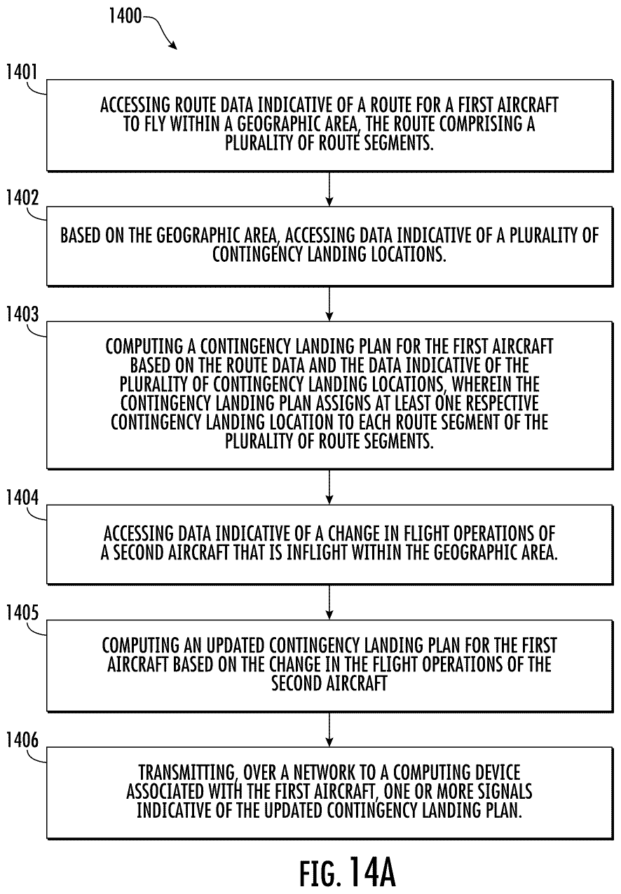

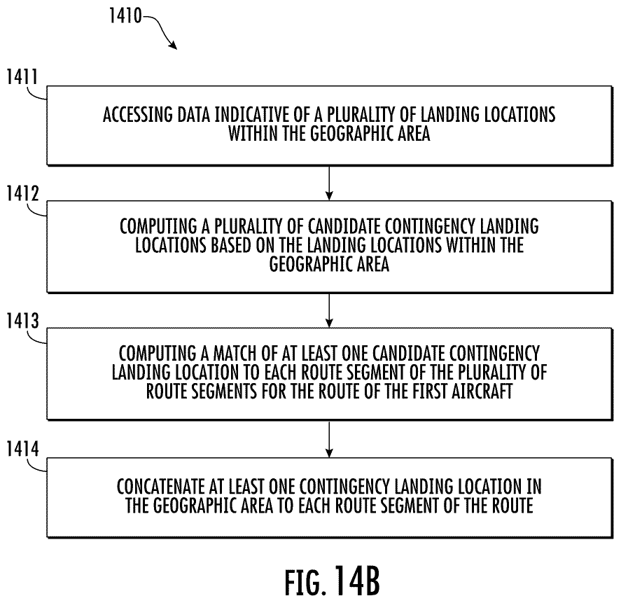

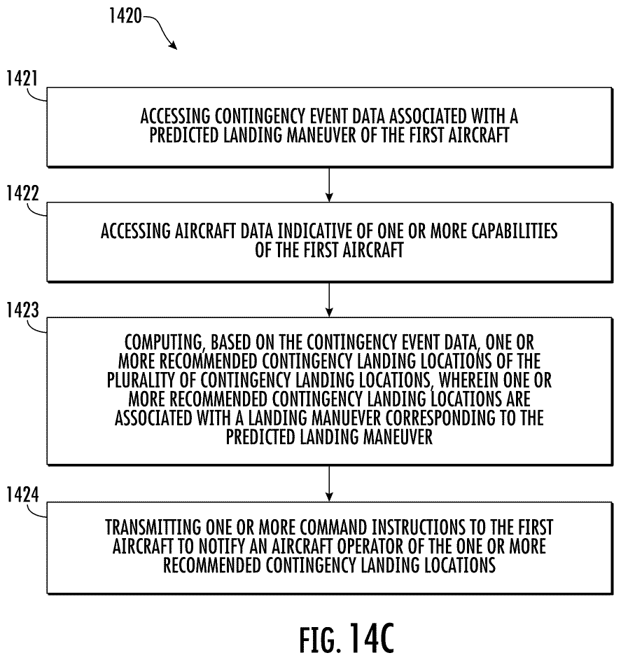

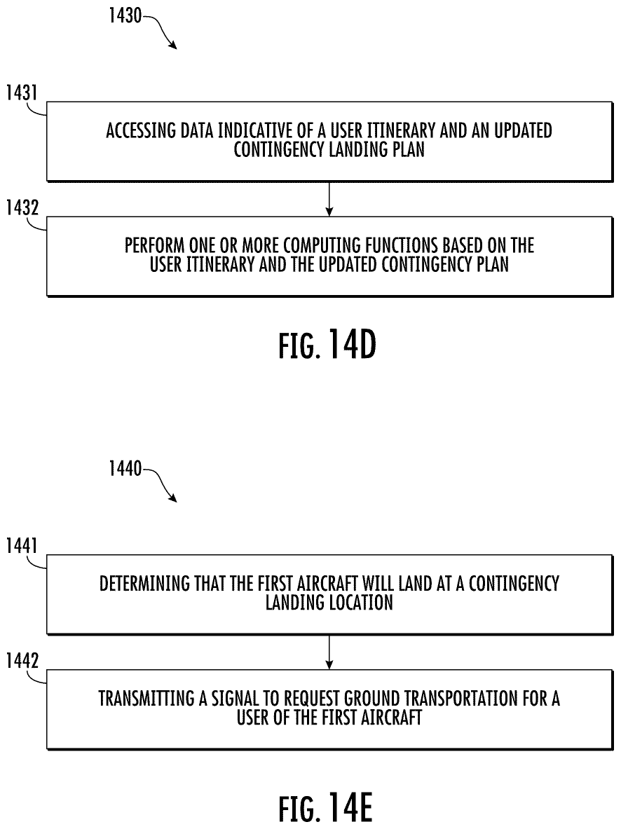

FIG. 14A-E depict flowchart diagrams of example computer-implemented methods according to example embodiments of the present disclosure. The methods can be performed by a computing system that includes one or more computing devices such as, for example, the computing systems described with reference to the other figures herein. Each respective portion of the methods can be performed by any (or any combination) of one or more computing devices. Moreover, one or more portions of these methods can be implemented as one or more algorithms on the hardware components of the devices described herein to perform the functions described herein with respect to computing and assigning contingency landing locations.

FIG. 14A-E depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

FIG. 14A-E are described with reference to elements/terms described with respect to other systems and figures for exemplary illustrated purposes and is not meant to be limiting. One or more portions of the methods can be performed additionally, or alternatively, by other systems.

FIG. 14A is a flowchart diagram of an example computer-implemented method 1400 for generating an updated contingency landing location for an aircraft according to example embodiments of the present disclosure.

At (1401), the method 1400 can include accessing route data indicative of a route for a first aircraft to fly within a geographic area. The route can include a plurality of route segments. For instance, a first aircraft of a fleet of aircraft operating in a geographic area can be assigned to perform a transportation service for one or more users. An ATP system can generate an itinerary for the first aircraft such that the first aircraft is assigned to a route to transport the one or more users. Route data can be generated indicating a concatenation of the first aircraft, the one or more passengers, and additional information associated with the transportation service.

A computing system (e.g., a contingency planning system) can access the route data, which includes a plurality of route segments that indicate a path of travel from a departure location to the destination location within the geographic area.

At (1402), the method 1400 can include, based on the geographic area, accessing data indicative of a plurality of contingency landing locations. For instance, the computing system can utilize an identifier associated with the geographic area to perform a look-up function to access landing location data. The landing location data can indicate all the landing locations for the given geographic area.

To access the data indicative of the plurality of contingency landing locations, the computing can filter the landing location data based on one or more criteria such as the parameters associated with the aircraft (e.g., contingency capabilities, landing capabilities, etc.), parameters associated with the landing locations (e.g., capacity, types of accommodated landings, etc.), or both.

The computing system can utilize the filtered landing locations to identify contingency landing locations that can be assigned to a particular route. By way of example, the computing system can filter the landing location data that indicates available landing locations within the geographic area, based on the route data that indicates a particular route, and the aircraft data that indicates an aircraft and its capabilities. The filtered landing location data can include contingency landing locations which satisfy parameters for the route. For instance, given the airspace corridors for a given route, the aircraft data can indicate that an aircraft can only land vertically during the route segments of the given route. As such the computing system can filter the landing location data to include landing locations which accommodate vertical landings. These locations can be candidates for contingency landing locations for the route.

At (1403), the method 1400 can include computing a contingency landing plan for the first aircraft based on the route data and the data indicative of the plurality of contingency landing locations. The contingency landing plan can assign at least one respective contingency landing location to each route segment of the plurality of route segments. For instance, the computing system can compute a contingency landing plan for the first aircraft prior to take-off. The contingency landing plan can indicate an assignment of contingency landing locations for each route segment within a route. The contingency planning system can be transmitted to a computing system associated with the aircraft prior to take-off, such that the aircraft has a provisional assignment of contingency landing locations before departure.

FIG. 14B depicts a flow diagram of an example method 1410 for computing a contingency landing plan. At (1411), as described herein, the computing system can access data indicative of a plurality of landing locations within the geographic area. The landing locations can include vertiports, building rooftops, open ground areas, etc.

At (1412), the computing system can compute a plurality of candidate contingency landing locations based on the landing locations within the geographic area. For instance, as described herein, the landing locations can be filtered based on a threshold distance to a route of the aircraft, based on the size/dimensions of the landing location, the permissible landing types, capacity, etc. The candidate contingency landing locations can be the landing locations within a geographic area that can accommodate the first aircraft.

The computing system can compute a contingency landing plan by computing a match of at least one candidate contingency landing location to each route segment of the plurality of route segments for the route of the first aircraft, at (1413).

By way of example, the computing system can parse route data to identify the various, distinct route segments of the route. For each route segment, the computing system can compare the distance from the waypoints of the route segment to the filtered contingency landing locations within the geographic area. Given the capabilities of the aircraft (e.g., its flight range given the estimated battery charge level at a particular segment) and the distance between the respective route segment to the candidate contingency landing locations, the computing system, can compute a ranking of contingency landing locations that the aircraft would be able to reach in an event that the aircraft needed to deviate from the route, at that route segment. The ranking of contingency landing locations can be based on factors such as distance, type of landing likely maneuver of the aircraft, capacity of the landing location, etc.

The highest ranked candidate for each route segment can be considered a match for the route segment. In some implementations, a particular set of ranked candidates can be identified as matches for a single route segment. This can be, for example, the top two or three ranked candidates.

At (1414), the computing system can concatenate at least one contingency landing location in the geographic area to each route segment of the route. For instance, based on the matching/ranking, the computing system can iteratively assign a contingency landing location to each route segment of a route. This can be done by linking the location identifier associated with the contingency landing location to an identifier associated with the respective route segment and storing the link in a data structure.

For a first route segment, this can include a first contingency landing location that is nearest to the waypoints of the route segment in terms of distance. Based on its current assignments and aircraft traffic due to transportation services, the first contingency landing location also has the capacity to have the aircraft land, if needed, during the timeframe the aircraft is estimated to fly along the first route segment. A second route segment can be assigned a second contingency landing location. The second contingency landing location may not be the closest landing location, but may be well within the range for an aircraft flying along the second route segment to quickly land for a contingency landing. This assignment may be due to the closest landing location not having the capacity for the aircraft or be available for the aircraft to perform a particular type of landing (e.g., because its FATOs do not accommodate the aircraft's size/configuration).

In some implementations, the computing system can perform this linking in series along the route segments until each route segment is assigned a contingency landing location. In some implementations, the computing system may assign contingency landing locations to route segments in no particular order.

For the aircraft/route, the computing system can compute a contingency landing plan that is indicative of the contingency landing location assigned to each route segment. The contingency landing plan can be generated such that the aircraft is assigned to an available contingency landing location at each point/segment along the route.

Returning to FIG. 14A, the computing system can update the contingency landing plan for an aircraft in real-time, based on the overall fleet of aircraft operating in the geographic area. For example, at (1420), the computing system can access data indicative of a change in flight operations of a second aircraft that is in-flight within the geographic area. As described herein, this data can be stored as vehicle operations data indicating the various locations, route deviations, flight maneuvers, etc. of the different aircraft in the geographic area.

For example, vehicle operations data can indicate a change in the operations of one or more aircraft based on other aircraft operating in the geographic area. By way of example, vehicle operations data can include real-time information indicating the progress or position of a second aircraft is delayed at a nearby vertiport. The delay of the second aircraft can cause an otherwise available landing capacity at the nearby vertiport to be unavailable. For instance, the first aircraft may include a contingency landing plan which includes the nearby vertiport as a contingency landing location for a first route segment. Based on the vehicle operations data, the computing system can compute a conflict whereby the nearby vertiport is assigned to the first aircraft and the second aircraft such the first aircraft will be unable to land at the nearby vertiport in the event of a contingency situation.

In some implementations, the change in flight operations can include the occurrence of a contingency event. For example, the landing area of a vertiport may experience damage such that the vertiport's capacity to function as a contingency landing location is reduced. An aerial facility device can provide data to the computing system to indicate the reduction in the capacity of the vertiport. In response, the computing system can update the contingency landing plan for an aircraft flying a route that has a route segment assigned to the vertiport.

At (1405), the computing system can compute an updated contingency landing plan for the first aircraft based on the change in the flight operations of the second aircraft. The updated contingency landing plan can include at least one change in the contingency landing locations assigned to the first aircraft for the route. For instance, the computing system can compute an updated contingency landing plan which resolves the conflict between the first aircraft and the second aircraft. The updated contingency landing plan for the first aircraft can remove the nearby vertiport from the list of contingency landing locations assigned to the first aircraft. For the first route segment, the computing system can assign a new contingency landing location for the first aircraft such that the first aircraft is assigned an available contingency landing location which can accommodate the first aircraft at each point during the flight.

In some examples, the computing system can iteratively compute updated contingency landing plans as the first aircraft flies along the assigned route, if needed.

At (1430), the computing system can transmit, over a network to a computing device associated with the first aircraft, one or more signals indicative of the updated contingency landing plan. For instance, the computing system can transmit the updated contingency landing plan as a data payload to a computing system associated with the first aircraft (e.g., an onboard computer, pilot device). The updated contingency landing plan can be utilized to update a user interface onboard the aircraft to reflect the updated contingency landing plan. For example, the user interface can be updated to indicate a nearby helipad as a contingency landing location for the first route segment.

The computing system can assist an aircraft operator based on the occurrence of a contingency event. FIG. 14C depicts a flow diagram of an example method 1420 for computing a contingency landing plan based on a contingency event.

At (1421), a computing system can access contingency event data associated with a predicted landing maneuver of the first aircraft. For instance, the computing system can access data that indicates the first aircraft is restricted from performing a vertical landing. This may be acceptable since the destination of the first aircraft (e.g., a private airstrip) may permit conventional landings.

At (1422), the computing system can compute, based on the contingency event data, one or more recommended contingency landing locations of the plurality of contingency landing locations. The one or more recommended contingency landing locations can be associated with a landing maneuver corresponding to the predicted landing maneuver. For example, a contingency landing plan may include a route segment that is assigned two potential contingency landing locations: a first contingency landing location that is only suitable for vertical landings (e.g., a building rooftop) and a second contingency landing location that is suitable for both conventional and vertical landings (e.g., an open field). Based on the first aircraft being restricted from performing a vertical landing, the computing system can determine that the second contingency landing location is recommended in the event a contingency landing location is required.

At (1423), the computing system can transmit one or more command instructions to the first aircraft to notify an aircraft operator of the one or more recommended contingency landing locations. For example, the computing system can transmit command instructions to an aircraft that can be processed by the computing devices of the aircraft. Processing of these instructions can result in a user interface onboard the aircraft highlighting (or otherwise emphasizing) the second contingency landing location for a pilot, de-emphasizing the first contingency landing location for a pilot, removing the first contingency landing location from a map interface, etc. The computing system can also update the contingency landing plan to remove the first contingency landing location assigned to the route segment.

The technology of the present disclosure can be used to update a user itinerary and provide services to a user of a transportation service. FIGS. 14C-D depicts flow diagrams of an example methods 1430 for facilitating the provision of a transportation service to a user.

For example, as described herein, a computing system can determine an updated contingency plan for an aircraft. In some implementations, the computing system can update a user itinerary based on the updated contingency plan. To do so, at (1431), the computing system can access (e.g., from a memory) a user itinerary for a user of a first aircraft. The user may have requested a multi-modal transportation service and the first aircraft may be transporting the user as part of that service. The user itinerary may indicate the user's origin, departure vertiport, arrival vertiport, ultimate destination, timing constraints, etc. The computing system can also access data indicative of the updated contingency plan.

At (1432), the computing system can perform one or more computing functions based on the user itinerary and the updated contingency. The computing functions can be associated with the transportation service being provided to the user. For example, the computing system can determine from the updated contingency plan that, if needed, the first aircraft transporting the user would land at a contingency landing location such as an open building rooftop. To help limit the amount of time the user spends at the contingency landing location (and to continue progressing the user towards their ultimate destination), the computing system can access data indicative of the supply of available ground transportation nearby the contingency landing location. The computing system can do so by, for example, calling an API of a ground transportation platform (GTP) system and transmitting a request structured according to the API. The request may inquire about the availability of potential ground transportation to transport the user from the contingency landing location. In response, the computing system can receive data indicative of the supply, wait times, etc. of such ground transportation.

The computing system can utilize this data to proactively request ground transportation for a user in the event the aircraft lands at the contingency landing location. For example, at (1441), the computing system can determine that the aircraft will land at the contingency landing location. This can be determined based on data indicating that the aircraft will land at that location, a pilot communication, a pilot's user input to an onboard user interface, the aircraft's heading, location, speed, etc.

In response, the computing system can transmit a signal to request ground transportation for the user of the first aircraft. This can be done while the user is still in-flight.

The computing system can submit a request (e.g., structured according to an API) for a ground vehicle to transport the user from the contingency landing location to the ultimate destination or another vertiport. A GTP system may receive such request, book a ground vehicle for the user, and return information to the computing system regarding the same. The computing system can transmit data to a user device of the user (or an intermediate computing system in communication therewith) to notify the user of the ground transportation, proactive booking, etc. in this way, the computing system can leverage the multi-modal transportation service to reduce the amount of time the user may spend at a contingency landing location.

### Example Computing System Components

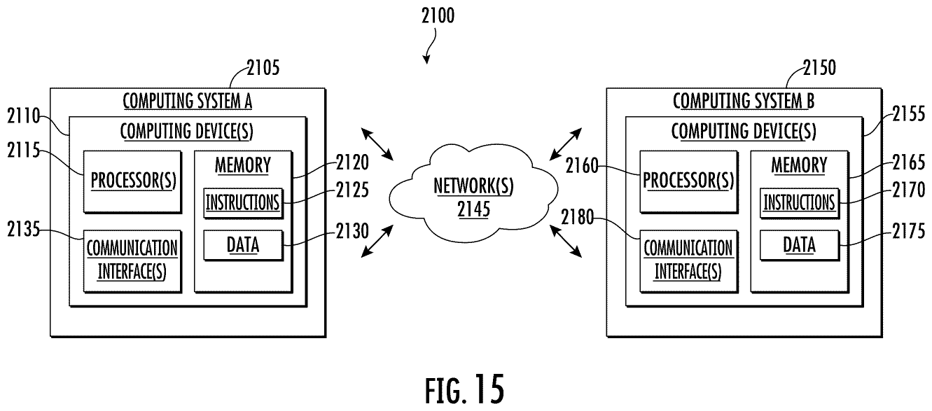

FIG. 15 depicts example system components of an example system 2100 according to example implementations of the present disclosure. The example system 2100 can include a computing system 2105 and a computing system 2150 that are communicatively coupled over one or more networks 2145. The computing systems 2105 and 2150 can represent, for example, computing systems that are onboard or offboard an aircraft, a cloud computing system, user computing system, or other systems/devices described herein.

The computing system 2105 can include one or more computing devices 2110. The computing devices 2110 of the computing system 2105 can include one or more processors 2115 and a memory 2120. The processors 2115 can be any suitable processing device (e.g., a processor core, a microprocessor, an ASIC, a FPGA, a controller, a microcontroller, etc.) and can be one processor or a plurality of processors that are operatively connected. The memory 2120 can include one or more non-transitory computer-readable storage media, such as RAM, ROM, EEPROM, EPROM, one or more memory devices, flash memory devices, etc., and combinations thereof.

The memory 2120 can store information that can be accessed by the processors 2115. For instance, the memory 2120 (e.g., one or more non-transitory computer-readable storage mediums, memory devices) can include computer-readable instructions 2125 that can be executed by the processors 2115. The instructions 2125 can be software written in any suitable programming language or can be implemented in hardware. Additionally, or alternatively, the instructions 2125 can be executed in logically and/or virtually separate threads on processors 2115.

For example, the memory 2120 can store instructions 2125 that when executed by the processors 2115 cause the processors 2115 to perform operations such as any of the processes/methods described herein or any of the operations and functions of any of the computing systems (e.g., aerial transportation platform system, ground transportation platform system, third party provider system, airspace system, etc.) and/or computing devices (e.g., user devices, ground vehicle devices, aircraft devices, aerial facility devices facility operator user devices, computing device 1500, etc.), as described herein.

The memory 2120 can store data 2130 that can be obtained, received, accessed, written, manipulated, created, and/or stored. The data 2130 can include, for instance, any of the data/information described herein. In some implementations, the computing devices 2110 can obtain from and/or store data in one or more memory devices that are remote from the computing system 2105 such as one or more memory devices of the computing system 2150.

The computing devices 2110 can also include a communication interface 2135 used to communicate with one or more other systems (e.g., computing system 2150). The communication interface 2135 can include any circuits, components, software, etc. for communicating via one or more networks (e.g., 2145). In some implementations, the communication interface 2135 can include for example, one or more of a communications controller, receiver, transceiver, transmitter, port, conductors, software and/or hardware for communicating data/information.

The computing system 2150 can include one or more computing devices 2155. The computing devices 2155 can include one or more processors 2160 and a memory 2165. The one or more processors 2160 can be any suitable processing device (e.g., a processor core, a microprocessor, an ASIC, a FPGA, a controller, a microcontroller, etc.) and can be one processor or a plurality of processors that are operatively connected. The memory 2165 can include one or more non-transitory computer-readable storage media, such as RAM, ROM, EEPROM, EPROM, one or more memory devices, flash memory devices, etc., and combinations thereof.

The memory 2165 can store information that can be accessed by the processors 2160. For instance, the memory 2165 (e.g., one or more non-transitory computer-readable storage mediums, memory devices) can store data 2175 that can be accessed e.g., obtained, received, written, manipulated, created, stored, pulled, etc. The data 2175 can include, for instance, any data or information described herein. In some implementations, the computing system 2150 can obtain data from one or more memory devices that are remote from the computing system 2150.

The memory 2165 can also store computer-readable instructions 2170 that can be executed by the processors 2160. The instructions 2170 can be software written in any suitable programming language or can be implemented in hardware. Additionally, or alternatively, the instructions 2170 can be executed in logically and/or virtually separate threads on processors 2160. For example, the memory 2165 can store instructions 2170 that when executed by the processors 2160 cause the processors 2160 to perform any of the operations and/or functions described herein, including, for example, any of the processes/methods described herein or the operations and functions of any of the computing systems (e.g., aerial transportation platform system, ground transportation platform system, third party provider system, airspace system, etc.) or computing devices (e.g., user devices, ground vehicle devices, aircraft devices, aerial facility devices facility operator user devices, computing device 1500, etc.), as described herein.

The computing devices 2155 can also include a communication interface 2180 used to communicate with one or more other systems. The communication interface 2180 can include any circuits, components, software, etc. for communicating via one or more networks (e.g., 2145). In some implementations, the communication interface 2180 can include for example, one or more of a communications controller, receiver, transceiver, transmitter, port, conductors, software and/or hardware for communicating data/information.

The networks 2145 can be any type of network or combination of networks that allows for communication between devices. In some implementations, the networks 2145 can include one or more of a local area network, wide area network, the Internet, secure network, cellular network, mesh network, peer-to-peer communication link and/or some combination thereof and can include any number of wired or wireless links. Communication over the networks 2145 can be accomplished, for instance, via a network interface using any type of protocol, protection scheme, encoding, format, packaging, etc.

FIG. 15 illustrates one example system 2100 that can be used to implement the present disclosure. Other computing systems can be used as well. Computing tasks discussed herein as being performed at computing devices remote from a vehicle/device can instead be performed at the vehicle/device, or vice versa. Such configurations can be implemented without deviating from the scope of the present disclosure.

### Additional Disclosure

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. The term “or” should be understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

What is claimed is:

1. A computer-implemented method comprising:
accessing route data indicative of a route for a first aircraft to fly within a geographic area, the route comprising a plurality of route segments;
based on the geographic area, accessing data indicative of a plurality of contingency landing locations;
computing a contingency landing plan for the first aircraft based on the route data and the data indicative of the plurality of contingency landing locations, wherein the contingency landing plan assigns at least one respective contingency landing location to each route segment of the plurality of route segments;
accessing data indicative of a change in flight operations of a second aircraft that is in-flight within the geographic area;
computing an updated contingency landing plan for the first aircraft based on the change in the flight operations of the second aircraft, the updated contingency landing plan comprising at least one change in the contingency landing locations assigned to the first aircraft for the route; and
transmitting, over a network to a computing device associated with the first aircraft, one or more signals indicative of the updated contingency landing plan.

2. The computer-implemented method of claim 1, further comprising:
accessing contingency event data associated with a predicted landing maneuver of the first aircraft;
computing, based on the contingency event data, one or more recommended contingency landing locations of the plurality of contingency landing locations, wherein one or more recommended contingency landing locations are associated with a landing maneuver corresponding to the predicted landing maneuver; and
transmitting one or more command instructions to the first aircraft to notify an aircraft operator of the one or more recommended contingency landing locations.

3. The computer-implemented method of claim 2, wherein the contingency event data is associated with a deviation from at least one route segment.

4. The computer-implemented method of claim 2, wherein the first aircraft is a vertical take-off and landing (VTOL) aircraft.

5. The computer-implemented method of claim 2, further comprising:
accessing aircraft data indicative of one or more capabilities of the first aircraft; and
computing, based on the one or more capabilities of the first aircraft, the one or more recommended contingency landing locations.

6. The computer-implemented method of claim 5, wherein the capabilities of the first aircraft are associated with a flight range of the first aircraft in response to a contingency event.

7. The computer-implemented method of claim 1, wherein the change in flight operations comprises at least one of: (i) a flight delay, (ii) a change in a route of the second aircraft, or (iii) a change in a capacity of at least one respective contingency landing location indicated in the contingency landing plan of the first aircraft.

8. The computer-implemented method of claim 1, wherein the contingency landing plan is computed prior to take-off.

9. The computer-implemented method of claim 1, wherein the plurality of contingency landing locations accommodate at least one of: (i) a vertical landing or (ii) a conventional landing.

10. The computer-implemented method of claim 1, wherein the landing maneuver is associated with at least one of: (i) a vertical landing or (ii) a conventional landing.

11. The computer-implemented method of claim 1, wherein the data indicative of the plurality of contingency landing locations comprises capacity data indicative of a respective capacity of each of the plurality of contingency landing locations.

12. The computer-implemented method of claim 1, wherein accessing data indicative of the change in flight operations of the second aircraft comprises:
accessing location data indicative of a position of the second aircraft within the geographic area.

13. The computer-implemented method of claim 1, wherein the change in the flight operations of the second aircraft comprises a route deviation by the second aircraft, and wherein computing the updated contingency landing plan for the first aircraft comprises:
computing the updated contingency landing plan for the first aircraft based on the route deviation of the second aircraft.

14. The computer-implemented method of claim 1, wherein the route for the first aircraft is a transportation route to transport one or more passengers in response to a transportation request.

15. The computer-implemented method of claim 1, wherein the plurality of route segments is associated with a path of travel from a first vertiport to a second vertiport.

16. The computer-implemented method of claim 1, wherein the at least one change in the contingency landing locations is associated with one or more contingency landing locations within a threshold distance from the first aircraft.

17. The computer-implemented method of claim 1, wherein the at least one respective contingency landing location to each route segment is a nearest contingency landing location of the plurality of contingency landing locations.

18. The computer-implemented method of claim 1, wherein data indicative of a change in flight operations is accessed from a storage system associated with transportation service.

19. A computing system comprising:
one or more processors; and
one or more non-transitory computer-readable media storing instructions that are executable by the one or more processors to perform operations, the operations comprising:
accessing route data indicative of a route for a first aircraft to fly within a geographic area, the route comprising a plurality of route segments;
based on the geographic area, accessing data indicative of a plurality of contingency landing locations;
computing a contingency landing plan for the first aircraft based on the route data and the data indicative of the plurality of contingency landing locations, wherein the contingency landing plan assigns at least one respective contingency landing location to each route segment of the plurality of route segments;
accessing data indicative of a change in flight operations of a second aircraft that is in-flight within the geographic area;
computing an updated contingency landing plan for the first aircraft based on the change in the flight operations of the second aircraft, the updated contingency landing plan comprising at least one change in the contingency landing locations assigned to the first aircraft for the route; and
transmitting, over a network to a computing device associated with the first aircraft, one or more signals indicative of the updated contingency landing plan.

20. A non-transitory computer-readable media storing instructions that are executable by one or more processors to cause the one or more processors to perform operations, the operations comprising:
accessing route data indicative of a route for a first aircraft to fly within a geographic area, the route comprising a plurality of route segments;
based on the geographic area, accessing data indicative of a plurality of contingency landing locations;
computing a contingency landing plan for the first aircraft based on the route data and the data indicative of the plurality of contingency landing locations, wherein the contingency landing plan assigns at least one respective contingency landing location to each route segment of the plurality of route segments;
accessing data indicative of a change in flight operations of a second aircraft that is in-flight within the geographic area;
computing an updated contingency landing plan for the first aircraft based on the change in the flight operations of the second aircraft, the updated contingency landing plan comprising at least one change in the contingency landing locations assigned to the first aircraft for the route; and
transmitting, over a network to a computing device associated with the first aircraft, one or more signals indicative of the updated contingency landing plan.
